(19) United States
(12) Patent Application Publication
(10) Pub. No.: US 2021/0131433 A1
(43) Pub. Date: May 6, 2021

(54) FLUID MACHINE

(71) Applicant: DENSO CORPORATION, Kariya-city (JP)

(72) Inventors: Shigeki IWANAMI, Kariya-city (JP); Keita SAITO, Kariya-city (JP); Harunobu NAKAYAMA, Kariya-city (JP)

(73) Assignee: DENSO CORPORATION, Kariya-city (JP)

(21) Appl. No.: 17/136,965

(22) Filed: Dec. 29, 2020

Related U.S. Application Data
(63) Continuation of application No. PCT/JP2019/022551, filed on Jun. 6, 2019.

(30) Foreign Application Priority Data
Jul. 3, 2018 (JP) 2018-126764
Dec. 13, 2018 (JP) 2018-233633

(51) Int. Cl. F04C 18/02

(52) U.S. Cl. CPC F04C 18/0215; F04C 18/0284; F04C 2240/50; F04C 2230/91; F04C 2240/30; F04C 2240/20

(57) ABSTRACT

A fixed scroll member includes a fixed base and a spiral fixed tooth member mounted to the fixed base. An orbiting scroll member is made of a resin material and includes an orbiting base arranged to face the fixed base; and a spiral orbiting tooth member. A housing is configured to house the fixed scroll member and the orbiting scroll member with the fixed scroll member being fixed thereto. An orbiting slide surface is located to be radially outside of the orbiting base of the orbiting scroll member, and a housing slide surface is formed on a portion of the housing. The portion is made of a metal material and is arranged to face the orbiting slide surface. The orbiting slide surface is in slidable contact with the housing slide surface. The portion of the housing has an outer wall exposed to atmospheric air.

### CROSS REFERENCE TO RELATED APPLICATION

This application is a bypass continuation application of currently pending international application No. PCT/JP2019/022551 filed on Jun. 6, 2019 designating the United States of America, the entire disclosure of which is incorporated herein by reference.

This application is based on and claims the benefit of priority from Japanese Patent Application No. 2018-126764 filed on Jul. 3, 2018 and Japanese Patent Application No. 2018-233633 filed on Dec. 13, 2018, the entire disclosure of each of which is incorporated herein by reference.

### TECHNICAL FIELD

The present disclosure relates to scroll-type fluid machines, and in particular to such scroll-type fluid machines used without lubricant oil.

### BACKGROUND

No-lubricant fluid machines are effective air pressure sources for cases where clean air, such as medical air or industrial air, are required, which eliminates the need of oil separators. Such a scroll-type fluid machine, which includes a movable member, is configured such that the movable member has a small orbital radius and a low sliding speed.

### SUMMARY

In a scroll-type fluid machine, an orbiting slide surface is located to be radially outside of an orbiting base of an orbiting scroll member. A housing slide surface is formed on a portion of the housing; the portion is made of a metal material and is arranged to face the orbiting slide surface. The orbiting slide surface is in slidable contact with the housing slide surface, and the portion of the housing has an outer wall exposed to atmospheric air.

### BRIEF DESCRIPTION OF THE DRAWINGS

FIG. 1 is a cross-sectional view of a fluid machine according to the first embodiment;

FIG. 2 is an enlarged view of a portion of FIG. 1, which is assigned with reference character II in FIG. 1;

FIG. 3 is a view describing a first example of how an orbiting slide surface of an orbiting scroll member with respect to a housing slide surface is operated;

FIG. 4 is a view describing a second example of how the orbiting slide surface of the orbiting scroll member with respect to the housing slide surface is operated;

FIG. 5 is a schematic perspective view illustrating a test apparatus for testing how one of two members slides on the other thereof;

FIG. 6 is a graph schematically illustrating a result of an orbiting test indicative of how one of two resin members slides on the other thereof;

FIG. 7 is a graph schematically illustrating a result of an orbiting test indicative of how one of a metal member and a resin member slides on the other thereof;

FIG. 8 is a graph schematically illustrating a result of an orbiting test indicative of how one of a metal member with coating and a resin member slides on the other thereof;

FIG. 9 is a cross-sectional view of a fluid machine according to the second embodiment;

FIG. 10 is an enlarged view of a portion of FIG. 9, which is assigned with reference character X in FIG. 9;

FIG. 11 is a cross-sectional view of a fluid machine according to the third embodiment;

FIG. 12 is a cross-sectional view of a fluid machine according to the fourth embodiment;

FIG. 13 is a cross-sectional view of a fluid machine according to the fifth embodiment;

FIG. 14 is a cross-sectional view of a fluid machine according to the sixth embodiment;

FIG. 15 is a partial cross-sectional view taken alone line XV-XV of FIG. 14, which shows an orbiting scroll member, a slide portion, and an intervening member;

FIG. 16 is a partial plan view of a restricting portion according to the seventh embodiment;

FIG. 17 is a partial longitudinal cross-sectional view of the restricting portion according to the seventh embodiment;

FIG. 18 is a partial plan view of the restricting portion according to the eighth embodiment;

FIG. 19 is a partial longitudinal cross-sectional view of the restricting portion according to the eighth embodiment;

FIG. 20 is a partial plan view of the restricting portion according to the ninth embodiment;

FIG. 21 is a partial longitudinal cross-sectional view of the restricting portion according to the ninth embodiment;

FIG. 22 is a partial cross-sectional view indicative of a positional relationship between the restricting portion and the intervening member according to the tenth embodiment;

FIG. 23 is a partial longitudinal cross-sectional view of a fluid machine according to the eleventh embodiment;

FIG. 24 is a partial longitudinal cross-sectional view of a fluid machine according to the twelfth embodiment; and

FIG. 25 is a partial longitudinal cross-sectional view of a fluid machine according to the thirteenth embodiment; and

FIG. 26 is a plan view illustrating only a sleeve member included in the fluid machine of the thirteenth embodiment.

### DETAILED DESCRIPTION OF EMBODIMENT

No-lubricant fluid machines are effective air pressure sources for cases where clean air, such as medical air or industrial air, are required, which eliminates the need of oil separators. Such a scroll-type fluid machine, which includes a movable member, is configured such that the movable member has a small orbital radius and a low sliding speed.

This feature of such a scroll-type fluid machine makes it easier to use such a scroll-type fluid machine as an air pressure source without lubricant supply.

Some of these scroll-type fluid machines, whose scroll members are each made of a metal material, have a manufacturing-cost disadvantage because the metallic scroll member needs a longer machining time.

From this viewpoint, Japanese Patent Application Publication No. S61-38187, which will be referred to as a first patent publication, discloses a scroll-type fluid machine including scroll members, i.e. fixed and orbiting scroll members, each of which is molded from a resin material.

Such a scroll-type fluid machine with a lower sliding speed has a characteristic of a lower PV value, which is the product of a surface pressure and the sliding speed. Unfortunately, such a scroll-type fluid machine, which is used without lubricant and is comprised of resin scroll members serving as sliding members, has a difficulty in its practical use, resulting in such a scroll-type fluid machine being of less practical use.

A scroll-type fluid machine described in the first patent publication includes scroll members each made of a costly superior resin material. In particular, if the slide portions of their scroll members were made of a resin material, the scroll-type fluid machine would have poor wear resistance. For this reason, the slide portions of the scroll members are respectively comprised of wear-resistant members.

Japanese Patent Application Publication No. H10-220367, which will be referred to as a second patent publication, discloses a scroll-type compressor. The scroll-type compressor includes a rotation prevention mechanism that is comprised of plural pairs of annular holes and pins. The annular holes are provided through a housing, and the pins are located respectively in the annular holes. Each of the pins is configured to circle along an inner circumferential surface of the corresponding one of the annular holes while the circle movement thereof is limited by the inner circumferential surface.

Intervening members are disposed in the respective annular holes, and the pins are loosely fit in the respective intervening members. Each intervening member is in slidable contact and rolling contact with both the annular hole and pin of a corresponding one pair of the annular holes and pins.

That is, the scroll-type compressor is configured such that the orbiting scroll member orbits around a predetermined center axis of the fixed scroll member while the rotation prevention mechanism prevents the orbiting scroll member from rotating.

Unfortunately, the fluid machine disclosed in the first patent publication include wear-resistant members formed on the respective scroll members, making the structure of the scroll-type fluid machine complicated. In addition, the orbiting scroll member of the fluid machine disclosed in the first patent publication includes a wear-resistant portion, resulting in the weight of the orbiting scroll member being larger. This may cause the fluid machine disclosed in the first patent publication to have a larger disadvantage of its vibration as centrifugal force of the orbiting scroll member increases.

The sliding portion of each of the fixed scroll member and the urning scroll member is comprised of the wear-resistant portion. This causes the slidable contact between the wear-resistant portions of the respective fixed and orbiting scroll members to generate heat, and the generated heat remains in the scroll members without being dissipated therefrom, resulting in the temperature of each scroll member becoming higher.

This temperature increase in the scroll members may result in abnormal wear in the slide portions of the respective scroll members. This temperature increase in the scroll members may cause the slide portions of the respective scroll members to undergo galling if the resin material of each of the scroll members has a relatively low melting point.

Specifically, the degree of hardness of resin is smaller than, for example, metal, so that resin has lower wear resistance than metal. Additionally, resin usually has a melting point lower than metal. An increase in temperature of the slide portions may cause wear of the slide portions to progress quickly, resulting in, in the worst case, the slide portions melting and adhering to each other, which is called galling set forth above.

Resin has a lower heat thermal conductivity than metal, i.e., resin has a lower thermal diffusivity than metal when each of resin and metal has the same load, i.e. when each has the same heat value, which substantially corresponds to the product of the weight and speed thereof. This may cause the slide portions to locally increase in temperature. This may cause the wearing of the slide portions to progress quickly, resulting in the slide portions being likely to melt to adhere to each other.

From this viewpoint, the scroll-type fluid machine described in the first patent publication is designed without considering heat transfer from the wear resistant portions of the scroll members. In addition, the scroll-type fluid machine described in the first patent publication is configured to include the wear resistant portions respectively provided in only the slide portions of the scroll members without considering external heat dissipation from the scroll-type fluid machine.

The rotation prevention mechanism disclosed in the second patent publication is configured such that the outer circumference of each pin is slidably contacted with the inner circumference of the corresponding intervening member, resulting in the circumferential speed of each pin and that of the corresponding intervening member being high. This feature of the rotation prevention mechanism may make it difficult to use the rotation prevention mechanism without lubricant supply, resulting in abnormal wear between each pin and the corresponding intervening member.

A first object of the present disclosure is therefore to provide scroll-type fluid machines usable without lubricant oil, each of which is comprised of an orbiting scroll member made of a resin material, and is designed to have a higher wear resistance and a higher reliability.

A second object of the present disclosure is to provide fluid machines, each of which is designed to reduce the wearing of a projection member and a corresponding intervening member of a rotation prevention mechanism.

Various exemplary aspects of the present disclosure respectively use different technical means for achieving their objects. Each parenthetic reference numeral described in the CLAIMS described later and this SUMMARY represents only an example of a specific relationship between a component of the CLAIMS and/or SUMMARY and a corresponding component described in one or more embodiments, and therefore the parenthetic reference numerals do not limit the technical scope of the present disclosure.

According a first exemplary aspect, a scroll-type fluid machine for discharging sucked fluid includes

(I) A fixed scroll member including a fixed base and a fixed tooth member mounted to the fixed base to have a spiral shape;

(II) An orbiting scroll member made of a resin material and including an orbiting base arranged to face the fixed base, and an orbiting tooth member mounted to the orbiting base to have a spiral shape, the fixed tooth member and the orbiting scroll member being fitted to each other, the orbiting scroll member being configured to orbit around a predetermined center axis

(III) A housing configured to house the fixed scroll member and the orbiting scroll member with the fixed scroll member being fixed thereto

(IV) An orbiting slide surface located to be radially outside of the orbiting base of the orbiting scroll member

(V) A housing slide surface formed on a portion of the housing, the portion being made of a metal material and being arranged to face the orbiting slide surface, the orbiting slide surface being in slidable contact with the housing slide surface, the portion of the housing having an outer wall exposed to atmospheric air.

This configuration causes the orbiting slide surface to slide on the housing slide surface while the orbiting scroll member is orbiting.

The housing is made of a metal material having a high heat conductivity, and is configured such that the outer wall of the housing is exposed to atmospheric air.

This configuration therefore causes heat generated due to sliding of the orbiting slide surface on the housing slide surface to be diffused through the metallic housing and thereafter to be dissipated from the outer wall of the housing into atmospheric air. This results in suppression of temperature increase due to the sliding of the orbiting slide surface on the housing slide surface, making it possible to improve the resistance of the orbiting slide surface and prevents melt-adhesion between the plastic slide surfaces. This therefore improves the reliability of the fluid machine.

Using the resin orbiting scroll member enables the weight of the fluid machine to be reduced, making it possible to reduce vibrations of the fluid machine due to orbiting of the orbiting scroll member. Using the resin orbiting scroll member also enables the manufacturing cost of the fluid machine to be reduced.

According to a second exemplary aspect, a scroll-type fluid machine for discharging sucked fluid includes

1. A fixed scroll member including a fixed base and a fixed tooth member mounted to the fixed base to have a spiral shape

2. An orbiting scroll member made of a resin material and including (i) an orbiting base arranged to face the fixed base, and (ii) an orbiting tooth member mounted to the orbiting base to have a spiral shape, the fixed tooth member and the orbiting scroll member being fitted to each other, the orbiting scroll member being configured to orbit around a predetermined center axis;

3. A first housing

4. A second housing, at least one of the first and second housings being made of a metal material and having an outer wall exposed to atmospheric air, an assembly of the first and second housing being configured to house the fixed scroll member and the orbiting scroll member with the fixed scroll member being fixed to the assembly of the first and second housings

5. An orbiting slide surface located to be radially outside of the orbiting base of the orbiting scroll member

6. A metallic spacer mounted to a portion of the first housing or the second housing, the portion being arranged to face the orbiting slide surface, the metallic spacer having a surface with which the orbiting slide surface being in slidable contact, the surface of the metallic spacer with which the orbiting slide surface being in slidable contact having a coating formed thereon, the coating having a self-lubricating characteristic

Applying the coating to the metallic spacer without applying coating to the first housing or the second housing, which has larger in size than the metallic spacer enables the load required to perform the coating-member applying process to be smaller. This therefore enables the manufacturing cost of the fluid machine to be lower.

In addition, it is possible to dissipate heat from one surface of the metallic spacer into atmospheric air. The fluid machine of the second exemplary aspect achieves beneficial effects that are substantially identical to the beneficial effects achieved by the first exemplary aspect.

According to a third exemplary aspect, a scroll-type fluid machine for discharging sucked fluid includes a fixed scroll member. The fixed scroll member includes a fixed warp member having a spiral shape, and an orbiting scroll member including an orbiting wrap member arranged to define a compression chamber between the fixed scroll member and the orbiting scroll member, the compression chamber being configured to compress fluid sucked thereinto and discharge the compressed fluid. The scroll-type fluid machine includes a plurality of rotation prevention mechanisms for preventing rotation of the orbiting scroll member.

Each of the rotation prevention mechanisms includes

1. A hollow restricting portion having a circular inner peripheral wall

2. A projection having predetermined first surface hardness and first predetermined surface roughness, and configured to orbit inside the restricting portion while being restricted by the inner peripheral wall of the restricting portion

3. A ring-shaped intervening member made of a material having predetermined second surface hardness

The intervening member has an inner peripheral portion that has predetermined second surface roughness, and is located to intervene between the projection and the inner peripheral wall of the restricting portion. The intervening member is configured to slide on both the projection and the inner peripheral wall of the restricting portion. The second surface hardness of the intervening member is set to be lower than the first surface hardness of the projection. The first surface roughness of the projection is set to be smaller than the second surface roughness of the inner peripheral portion of the intervening member.

Because the surface hardness of the intervening member is smaller than that of the projection, the inner peripheral portion of the intervening member will be more easily worn than the outer peripheral portion of the projection so as to confirm to the projection with the smaller surface roughness. If the slide portion of the intervening member conforms sufficiently to the slide portion of the projection, the surface resistance between the projection and the intervening member will become small. This therefore reduces wearing of the intervening member and the projection, and inhibits seizing between the intervening member and the projection.

Accordingly, the third exemplary aspect provides such a fluid machine configured to slow down wearing of the projection in each rotation prevention mechanism.

If a resin material is used as a material for each of the fixed scroll member and orbiting scroll member, which has a benefit in cost and in vibration, without lubricating oil, it is necessary to balance both the wear resistance of a rotation prevention mechanism and the wear resistance of thrust slide portions.

From this viewpoint, the scroll-type fluid machine described in the first patent publication incudes metallic wear-resistant portions formed respectively on the slide portions, because resin slide portions of the respective scroll members may have difficulty in maintaining sufficient wear resistance of the thrust slide portions.

Unfortunately, because the metallic wear-resistant portions are formed only on the respective slide portions of the fixed and orbiting scroll members, heat generated by the sliding of the slide portion of the orbiting scroll member on the slide portion of the fixed scroll member may remain without being dissipated to the outside, resulting in an increase in temperature of both the fixed and orbiting scroll members due to delay of heat dissipation. This therefore may cause abnormal wearing of the slide portions of the scroll members. If a resin material for at least one of the scroll members has a relatively low melting point, the temperature increase in the slide portions may result in the side portions melt-adhering to each other.

From this viewpoint, in addition to the disclosure of each rotation prevention mechanism, a fourth exemplary aspect includes a housing. The housing is provided to be integral with or individually separated from the fixed scroll member. The housing is configured to house the fixed scroll member and the orbiting scroll member. The fourth aspect includes an orbiting slide surface located to be radially outside of the base of the orbiting scroll member, and an orbiting slide surface located to be radially outside of the base of the orbiting scroll member. The fourth aspect includes a housing slide surface formed on a portion of the housing, the portion being made of a metal material and being arranged to face the orbiting slide surface, the orbiting slide surface being in slidable contact with the housing slide surface. The portion of the housing has an outer wall exposed to atmospheric air.

This configuration causes the orbiting slide surface to slide on the housing slide surface while the orbiting scroll member is orbiting.

The portion of the housing, on which the housing slide surface is formed, is made of a metal material, and the outer wall of the portion of the housing is exposed to atmospheric air. This configuration therefore causes heat generated due to sliding of the orbiting slide surface on the housing slide surface to be diffused through the metallic housing and thereafter to be dissipated from the outer wall of the housing into atmospheric air. This results in suppression of temperature increase due to the sliding of the orbiting slide surface on the housing slide surface, making it possible to improve the resistance of the orbiting slide surface and prevents melt-adhesion between the plastic slide surfaces. This therefore improves the reliability of the fluid machine, and balances both the wear resistance of a rotation prevention mechanism and the wear resistance of thrust slide portions. This makes it possible for the fluid machine to perform various functions even if no lubricating oil is supplied thereto.

Each parenthetic reference numeral assigned to a corresponding component of each exemplary aspect represents an example of a specific relationship between the corresponding component in the corresponding exemplary aspect and the corresponding component described in one or more embodiments described later.

The following describes embodiments for implementing the present disclosure with reference to the accompanying drawings. Components of each embodiment, which correspond to those of one or more already-described embodiments, are denoted by the same reference characters or numerals, and therefore description of the components of each embodiment may be omitted. In each embodiment, if only a part of a structure is described, description of the remaining of the structure, which has been already shown in one or more already-described embodiments, can be applied to the remaining of the structure of the corresponding one of the embodiments.

One or more components of each embodiment can be combined with one or more components of other embodiments, even if the combinations are not disclosed in any of the embodiments, as long as the combinations provide no problems.

### First Embodiment

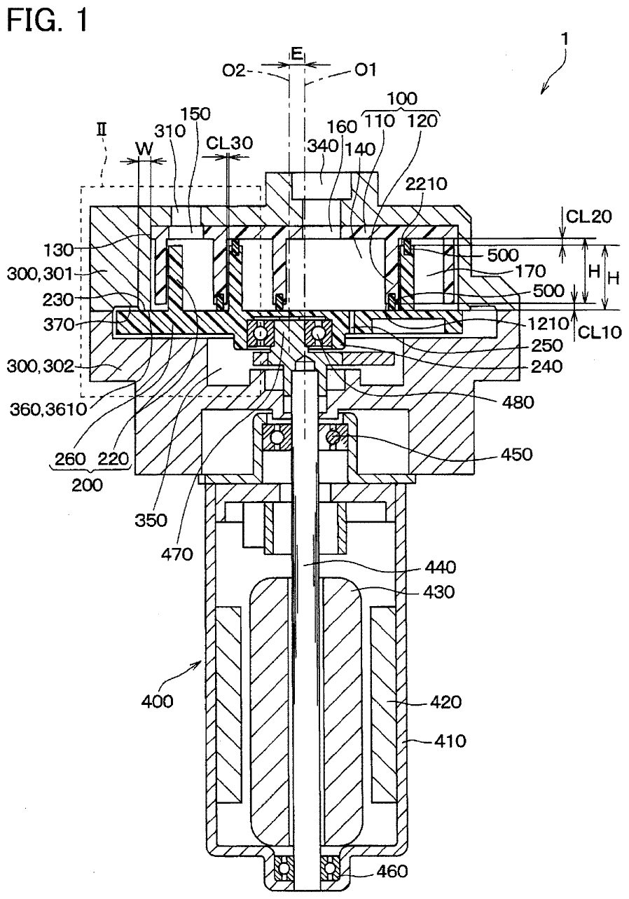

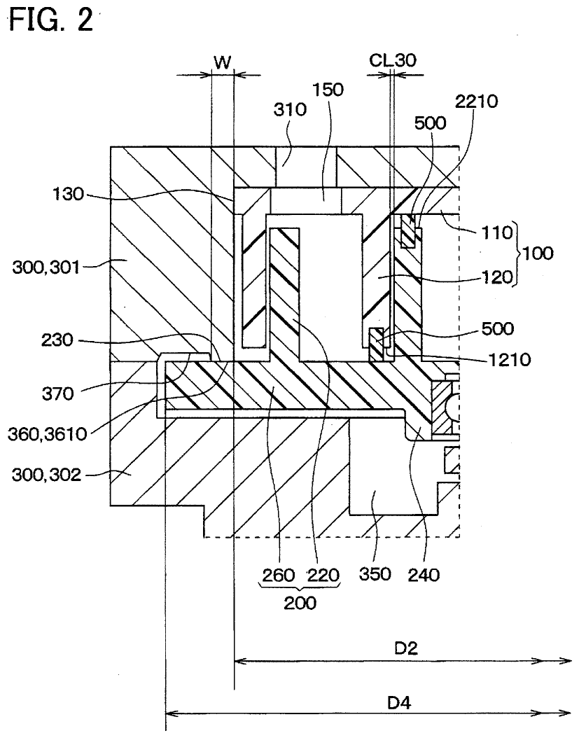

The following describes the first embodiment with reference to FIGS. 1 and 2.

A fluid machine 1 of the first embodiment is designed as a scroll-type fluid machine used without lubricant oil; the fluid machine 1 is comprised of a fixed scroll member made of a resin material and an orbiting scroll member made of a resin material.

The fluid machine 1 of the first embodiment, which is configured to be used without lubricant oil, eliminates the need of providing accessories, such as oil separators. The fluid machine 1 is used as an air compressor that supplies clean air, such as medical air or industrial air. The fluid machine 1 is configured to suck air as an example of fluid, and discharge compressed air as compressed fluid.

Referring to FIG. 1, the fluid machine 1 of the first embodiment is comprised of a housing 300, the fixed scroll member 100 described above, the orbiting scroll member 200 described above, and a motor unit 400.

The housing 300 is comprised of a first housing 301 and a second housing 302. Each of the first and second housings 301 and 302 is made of a metal material, such as aluminum, with a high heat conductivity. The first and second housings 301 and 302 are fixedly assembled to each other with unillustrated bolts or fixedly welded to each other. Each of the first and second housings 301 and 302 has an outer wall exposed to atmospheric air. At least part of each of the first and second housings 301 and 302 should be made of a metal material, so that the remaining part thereof can be made of another material. At least part of each of the first and second housings 301 and 302 should be exposed to atmospheric air, so that the remaining part thereof can be unexposed to atmospheric air.

The housing 300 is configured to house the fixed scroll member 100 and the orbiting scroll member 200. The following also describes the fixed scroll member 100 and the orbiting scroll member 200 simply as scroll members 100 and 200.

The scroll members 100 and 200 are configured as a compressing unit that sucks air, compresses the sucked air, and discharges the compressed air.

The fixed scroll member 100, which is made of a resin material, is comprised of a fixed base 110 having a substantially discotic shape, and a fixed tooth member 120 disposed on the fixed base 110. The fixed tooth member 120 is mounted to the fixed base 110 to have a spiral shape as seen in the axial direction of the fixed base 110, which is not shown in the drawings. The fixed base 110 has a radial outer wall 130 that is, for example, pressed to be fitted in an inner wall of the first housing 301, thus the outer wall 130 being fixed to the inner wall of the first housing 301. A portion of the inner wall of the first housing 301 in which the outer wall 130 is fitted will also be referred to as a fit portion.

The fixed scroll member 100 and the orbiting scroll member 200 define compression chambers 140 therebetween. The fixed base 110 of the fixed scroll member 100 has a supply hole 150 formed therethrough for enabling air to be supplied therethrough into each of the compression chambers 140. The fixed base 110 of the fixed scroll member 100 also has a discharge hole 160 formed therethrough for discharging air stored in each of the compression chambers 140 out of the compression chamber 140.

The first housing 301 has a supply port 310 communicating with the supply hole 150 of the fixed scroll member 100. The first housing 301 also has a discharge port 340 communicating with the discharge hole 160 of the fixed scroll member 100.

The orbiting scroll member 200 is comprised of an orbiting base 260 having a substantially discotic shape, and an orbiting tooth member 220 disposed on the orbiting base 260. The orbiting tooth member 220 is mounted to the orbiting base 260 to have a spiral shape as seen in the axial direction of the orbiting base 260. The orbiting scroll member 200 is made of a resin material. The orbiting base 260 has an outer portion that is located to be radially outside of the orbiting tooth member 220. The outer portion of the orbiting base 260 has an orbiting slide surface 230 formed thereon; the orbiting slide surface 230 is in slidable contact with the inner wall of the first housing 301. How the first housing 301 and the orbiting slide surface 230 are slidably contacted with each other will be described later.

The orbiting tooth member 220 of the orbiting scroll member 200 and the fixed tooth member 120 of the fixed scroll member 100 are fitted to each other to constitute the compression chambers 140 on a first side of the orbiting base 260. Each of the compression chambers 140 is configured to compress air stored therein. Although being not shown in the figures, each of the compression chambers 140 has a crescent shape as seen from the axial direction of the scroll members 100 and 200.

A cylindrical boss member 240 is mounted on a second side of the orbiting base 260, which is opposite to the first side thereof. An unillustrated rotation prevention mechanism is provided to the orbiting scroll member 200; the rotation prevention mechanism is configured to prevent the orbiting scroll member 200 from rotating.

A motor unit 400 is provided at the outer side of the second housing 302. The motor unit 400 includes a motor case 410, a stator 420, a rotor 430, and a shaft 440; these components 420, 430, and 440 are installed in the motor case 410. A selected one of various types of motors, such as a brush motor or a brushless motor, can be used as the motor unit 400. The shaft 440 is mounted to the motor case 41 via bearings 450 and 460 installed in the motor case 41 so as to be rotatable around a center axis O1. That is, the center axis O1 serves as a rotational axis around which the shaft 440 is rotated.

The shaft 440 has opposing first and second ends. The first end of the shaft 440 is disposed in the second housing 302. An eccentric member 470 is fixed to the first end of the shaft 440. The eccentric member 470, which has a center O2, is located such that the center O2 is eccentrically arranged from the center axis O1 of the shaft 440. The eccentric member 470 is provided in the boss portion 240 via a bearing 480.

When the motor unit 400 is energized, the shaft 440 is rotated around the center axis O1, so that the motor unit 40 outputs torque. The torque outputted from the motor unit 440 is transferred to the boss portion 240 of the orbiting scroll member 200 via the eccentric member 470. The torque transferred to the orbiting scroll member 200 from the eccentric member 470 causes the orbiting scroll member 200 to orbit around the center axis O1 of the shaft 440 while rotation of the orbiting scroll member 200 is prevented by the unillustrated rotation prevention mechanism. Orbiting of the orbiting scroll member 200 causes each of the compression chambers 140 formed between the scroll members 100 and 200 to pivotally move from the radially outer side to the radially inner side, resulting in the volume of each of the compression chambers 140 being gradually reduced. This gradual reduction of the volume of each of the compression chambers 140 causes air supplied from the supply port 310 into the corresponding one of the compression chambers 140 via the supply hole 150 to be compressed, and the compressed air in each compression chamber 140 is discharged from the discharge hole 160 via the discharge port 340.

The second side of the orbiting base 260 and the inner wall of the second housing 302 provide a back-pressure chamber 350 therebetween. Into the back-pressure chamber 350, a part of the air compressed by the compression chambers 140 is supplied via a back-pressure introduction hole 250 formed through the orbiting base 260. The pressure of the air supplied in the back-pressure chamber 350 causes the orbiting scroll member 200 to be biased toward the fixed scroll member 100.

As described above, the orbiting slide surface 230 is formed at the outer portion of the orbiting base 260, which is located to be radially outside of the orbiting tooth member 220; the orbiting slide surface 230 is in slidable contact with the inner wall of the first housing 301.

The first housing 301 has a portion that faces the orbiting slide surface 230, and the portion of the first housing 301 has a housing slide surface 360 formed thereon; the orbiting slide surface 230 is in slidable contact with the housing slide surface 360.

Pressure of air stored in the back-pressure chamber 350 biases the orbiting scroll member 200 toward the fixed scroll member 100 when the orbiting scroll member 200 orbits. This biasing causes the orbiting slide surface 230 to slide while the orbiting slide surface 230 is constantly contacted with the housing slide surface 360. This results in the housing slide surface 360 serving as a thrust bearing that is subjected to an axial load of the orbiting scroll member 200. That is, the orbiting scroll member 200 orbits while being supported by the housing slide surface 360 serving as the thrust bearing.

If there were a clearance between the orbiting slide surface 230 and the housing slide surface 360, high-pressure air supplied from the compression chambers 140 to the back-pressure chamber 350 would pass through the clearance to leak into a low-pressure space 170 located inside of the fixed scroll member 100.

In contrast, the biasing of the orbiting scroll member 200 toward the fixed scroll member 100 based on the pressure of air stored in the back-pressure chamber 200 enables the orbiting slide surface 230 to slide while the orbiting slide surface 230 is reliably contacted with the housing slide surface 360. This prevents high-pressure air in the back-pressure chamber 350 from leaking into the low-pressure space 170 located inside of the fixed scroll member 100. The above configured liquid machine 1 therefore prevents a reduction in the compression efficiency of air.

The housing slide surface 360 has a coating member 3610 formed thereon; the coating member 3610 is composed of fluorine or molybdenum disulfide, which has self-lubricating characteristics. The coating member 3610 coated on the housing slide surface 360 enables the frictional coefficient of the housing slide surface 360 to be lower. As the fluorine coating, polytetrafluoroethylene (PTFE) coating can be preferably used.

The coating member 3610 coated on the housing slide surface 360 is designed as a thin film, making it possible to maintain heat transfer from the orbiting scroll member 200 to the housing 300. This therefore suppresses an increase in temperature of the slidable contact portions, i.e. the slidably contact surfaces 230 and 360, even if the contact surface 230 is slidably contacted with the contact surface 360 under high load to the housing slide surface 360.

As illustrated in FIGS. 1 and 2, the first housing 301 has a concave recess 370 formed in a radially outer portion of the housing slide surface 360. The concave recess 370 is dented inwardly in the radially outer portion of the housing slide surface 360 to be away from the orbiting slide surface 230. The concave recess 370 of the first housing 301 is in a non-slidable contact with the orbiting slide surface 230 of the orbiting scroll member 200. Designing the concave recess 370 enables the housing slide surface 360 to have a predetermined radial width W.

The radial width W of the housing slide surface 360 and an eccentric distance E of the orbiting scroll member 200 with respect to the center axis O1 of the revolution of the scroll member 200 are set to be substantially equal to each other. The eccentric distance E of the orbiting scroll member 200, which is eccentrically arranged with respect to the center axis O1 of the revolution of the scroll member 200, is set to be equal to a distance E between the center O2 of the eccentric member 470 and the center axis O1 of the shaft 440. The present disclosure is however not limited to this setting of the radial width W.

Specifically, the radial width W of the housing slide surface 360 can be set to be smaller than or equal to a double of the eccentric distance E of the orbiting scroll member 200 with respect to the center axis O1 of the revolution of the scroll member 200. This setting of the radial width W of the housing slide surface 360 enables the orbiting slide surface 230 to intermittently slide on the housing slide surface 360.

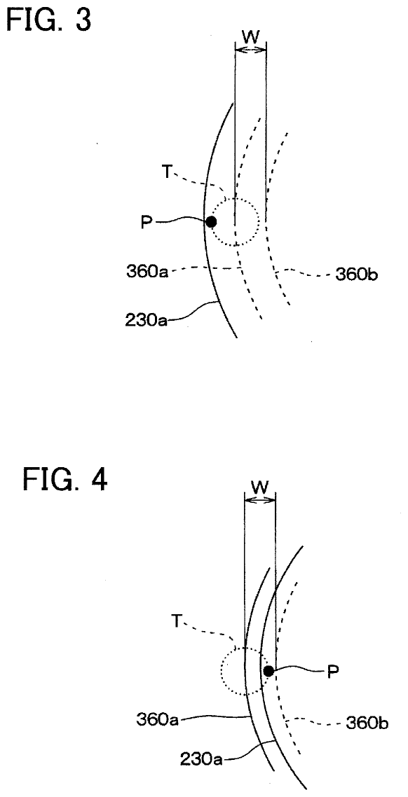

The following describes the intermittent sliding of the orbiting slide surface 230 on the housing slide surface 360 with reference to FIGS. 3 and 4.

Each of FIGS. 3 and 4 illustrates a relationship between the orbiting slide surface 230 of the orbiting scroll member 200 and the housing slide surface 360 when viewed from the axial direction.

In each of FIGS. 3 and 4, an outer circumferential edge of the orbiting slide surface 230 of the orbiting scroll member 20 is assigned with a reference numeral 230a. In each of FIGS. 3 and 4, any slidable point on the orbiting slide surface 230 is assigned with a reference character P, and a trajectory T along which the slidable point P orbits is expressed by a dashed line. Moreover, in each of FIGS. 3 and 4, an outer circumferential edge of the housing slide surface is assigned with a reference numeral 360a, and an inner circumferential edge of the housing slide surface 360 is assigned with a reference numeral 360b. The phase of the revolution of the orbiting scroll member 200 illustrated in FIG. 3 and the phase of the revolution of the orbiting scroll member 20 illustrated in FIG. 4 have a difference of 180 degrees.

In each of FIGS. 3 and 4, the radial width W of the housing slide surface 360 is substantially equal to the eccentric distance E of the orbiting scroll member 200, which is eccentrically arranged with respect to the center axis O1 of the revolution of the scroll member 200. In other words, the radial width W of the housing slide surface 360 is substantially equal to a radius of the trajectory T along which the slidable point P orbits. This results in (i) substantially half of the trajectory T being located outside of the housing slide surface 360 and (ii) the remaining substantially half of the trajectory T being located on the housing slide surface 360. The leads to the fact that a time for which the slidable point P on the orbiting slide surface 230 slides on the housing slide surface 360 becomes a substantially 50% of the total working time of the fluid machine 1. Hereinafter, the ratio of the time for which the slidable point P on the orbiting slide surface 230 slides on the housing slide surface 360 to the total working time of the fluid machine 1 will be referred to as a slide ratio.

As described above, each of the first and second housings 301 and 302 is made of a metal material, and each of the scroll members 100 and 200 is made of a resin material. Usually, a thermal expansion rate of metal is larger than that of resin. For this reason, the first embodiment is configured such that the scroll members 100 and 200 are non-contacted with each other upon an increase in the temperature of the fluid machine 1.

As illustrated in FIG. 1, a tip end 1210 of the fixed tooth member 120 of the fixed scroll member 100 and the orbiting base 260 of the orbiting scroll member 200 define a predetermined clearance CL1 therebetween. In addition, a tip end 2210 of the orbiting tooth member 220 of the orbiting scroll member 200 and the fixed base 110 of the fixed scroll member 100 define a predetermined clearance CL20 therebetween. This results in the tip end 1210 of the fixed tooth member 120 being located to be closer to the fixed base 11 than the orbiting slide surface 230 and the housing slide surface 360 are. This arrangement enables the orbiting slide surface 230 to slide on the housing slide surface 360 while being reliably in contact with the housing slide surface 360. This reliable contact between the surfaces 230 and 360 during sliding of the surface 230 prevents high-pressure air in the back-pressure chamber 350 from leaking into the low-pressure space 170 located inside of the fixed scroll member 100.

The tip end 1210 of the fixed tooth member 120 has a tip seal 500 formed thereon, and the tip end 2210 of the orbiting tooth member 220 has a tip seal 500 formed thereon. The tip seals 500 prevent air in the compression chambers 140 from leaking via the clearances CL10 and CL20 in a thrust direction.

The fixed tooth member 120 or the orbiting tooth member 220 has a predetermined height to which reference character H is assigned, and the fluid machine 1 has a useable temperature range with an upper limit to which reference character ΔT. Each of the scroll members 100 and 200 has a predetermined linear expansion coefficient to which reference character α1 is assigned, and the first housing 301 has a linear expansion coefficient α2.

This enables the clearance CL10 related to the tip end 1210 of the fixed tooth member 120 and the clearance CL20 related to the tip end 2210 of the orbiting tooth member 220 to be expressed by the following respective formulas (1) and (2):

CL10>H×ΔT×(α1−α2) (1)

CL20>H×ΔT×(α1−α2) (2)

Setting the clearance CL10 related to the tip end 1210 of the fixed tooth member 120 and the clearance CL20 related to the tip end 2210 of the orbiting tooth member 220 as described above prevents strong contact between the tip end 1210 of the fixed tooth member 120 and the tip end 2210 of the orbiting tooth member 220. This accordingly results in there being no clearance between the orbiting slide surface 230 and the housing slide surface 360, making it possible to prevent high-pressure air in the back-pressure chamber 350 from leaking into the low-pressure space 170 located inside the fixed scroll member 100.

In addition, the scroll members 100 and 200 according to the first embodiment are arranged to continuously define a predetermined clearance CL30 between a part of a side surface of the fixed tooth member 120 and a corresponding part of an opposite side surface of the orbiting tooth member 220 while the orbiting scroll member 200 is orbiting; the part of the side surface of the fixed tooth member 120 and the corresponding part of the side surface of the orbiting tooth member 220 are closest to each other while the orbiting wall member 200 is orbiting. This configuration prevents the wearing away of each of the side surfaces of the respective tooth members 120 and 220 and melt-adhesion between the side surfaces of the respective tooth members 120 and 220.

The length of the clearance CL 30 is set to be identical to the height H of each of the tooth members 120 and 220, so that the length of the clearance CL 30 is shorter than a circumferential length of the clearance CL10 related to the tip end 1210 of the fixed tooth member 120 and that of the clearance CL20 related to the tip end 2210 of the orbiting tooth member 220. This results in the clearance CL30 having small influence on the compression efficiency of air.

The first embodiment is configured such that torque outputted from the motor unit 400 causes the orbiting scroll member 200 to orbit, and orbiting of the orbiting scroll member 200 causes the orbiting slide surface 230 to slide on the housing slide surface 360. Heat generated due to the slide of the orbiting slide surface 230 on the housing slide surface 360 is diffused through the metallic first and second housings 301 and 302 without staying at the surfaces 230 and 360 and thereafter is discharged from the outer walls of the housing 301 and 302. This reduces an increase in the temperature of the orbiting slide surface 230 and housing slide surface 360 due to the sliding of the surface 230 on the surface 360, making it possible to improve the resistance of the orbiting slide surface 230 and prevents melt-adhesion between the plastic slide surfaces.

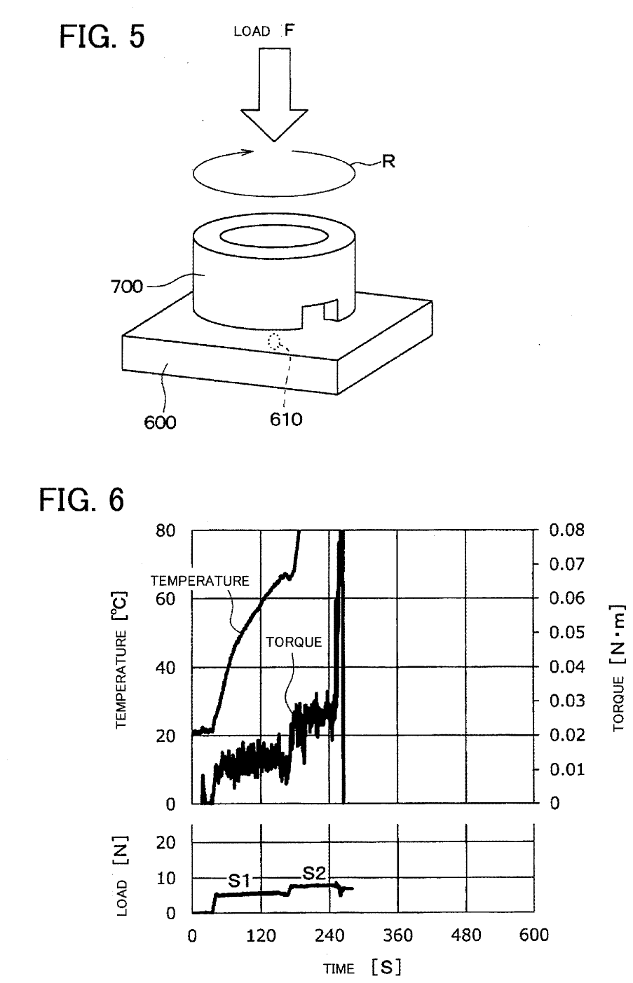

Next, the following describes results of an experiment carried out for ascertaining how the first embodiment works to achieve beneficial effects. As illustrated in FIG. 5, this experiment used a planar resin plate 600 and a cylindrical member 700 as test pieces. Specifically, a planar plate made of polyphenylenesulfide (PPS) was used as the resin plate 600, and three types of cylindrical members were prepared as the cylindrical member 700. The first type of cylindrical member 700 is made of PPS, the second type of cylindrical member 700 is made of aluminum, and the third type of cylindrical member 700 is made of a PPS material, the second type of cylindrical member 700 is made of aluminum with each slide surface coated with PTFE. Hereinafter, the resin plate 600 can also be called as a test piece 600, and the three types of cylindrical members 700 can be called as test pieces 700.

This experiment placed a selected one of the cylindrical members 700 on the resin plate 600.

Then, this experiment performed an orbiting test of causing the selected cylindrical member 700 to rotate in a predetermined circumferential direction R at a constant rate with predetermined load F being applied to the cylindrical member 700 in an axial direction of the cylindrical member 700.

During the orbiting process, while the load F applied to the selected cylindrical member 700 were increased step by step every lapse of a predetermined time since the start of the orbiting test, temperature change of the slide surfaces of the resin plate 600 and the selected cylindrical member 700 and torque required to turn the selected cylindrical member 700 are measured. Note that temperature change of the slide surfaces of the resin plate 600 and the selected cylindrical member 700 was measured with a thermocouple 610 located under the slide surface of the resin plate 600.

In the following descriptions, the steps of the orbiting test, each of which is related to a corresponding increase in the load F to be applied to the selected cylindrical member 700 will be referred to a first step S1, a second step S2, . . . . That is, when the orbiting test increases by a single step, the load F to be applied to the selected cylindrical member 700 is increased.

A graph of FIG. 6 shows a result of the orbiting test using the resin plate 600 made of PPS and the selected cylindrical member 700 made of PPS. The result of the orbiting test shows that the measured temperature of the slide surfaces increases in the first step S1, and thereafter rapidly increases in the second step S2 while the measured torque also increases rapidly. For this reason, the following steps after the second step were cancelled, and at this time, the test pieces 600 and 700 were checked so that their resins were melted to be adhered to each other.

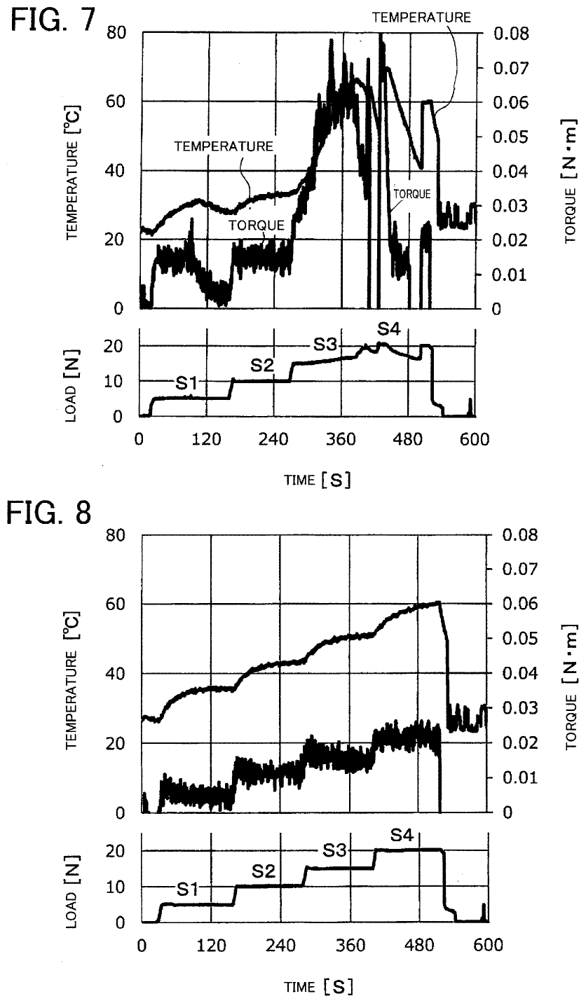

A graph of FIG. 7 shows a result of the orbiting test using the resin plate 600 made of PPS and the selected cylindrical member 700 made of aluminum. The result of the orbiting test shows that the measured temperature of the slide surfaces increases very gradually during the sequence from the first step S1 to the second step S2. The measured temperature and measured torque however increase rapidly in the third step S3. After the orbiting test, the slide surfaces of the test pieces 600 and 700 were checked and it was found that the slide surfaces show a tendency of undergoing melt-adhesion between the slide surfaces.

A graph of FIG. 8 shows a result of the orbiting test using the resin plate 600 made of PPS and the selected cylindrical member 700 made of aluminum with each slide surface coated with PTFE. The result of the orbiting test shows that no rapid temperature increase appears the sequence from the first step S1 to the fourth step S4. After the orbiting test, the slide surfaces of the test pieces 600 and 700 were checked so that the slide surfaces show no melt-adhesion therebetween.

The above experiment using the orbiting tests have found the following first to third conclusions:

The first conclusion is that, if the resin member slides on the resin member, the temperature of their slide portions locationally increases because resins have low heat transfer ratios, so that the slide portions soften to be melted, resulting in melt-adhesion of the slide portions.

The second conclusion that, if the slide surface of one of the resin members is made of a material, such as aluminum, with a high heat conductivity, it is possible to suppress a temperature increase in the slide surface, resulting in a reduction in the temperature of the slide surfaces. Using a material with a high conductivity to make the slide surface of one of the resin members therefore prevents the resin members from being melted and adhered to each other.

Additionally, comparing the aluminum slide surface without PTFE coating illustrated in the graph of FIG. 7 and the aluminum slide surface with PTFE coating illustrated in the graph of FIG. 8 has found the following matters.

Specifically, the configuration that the aluminum test piece 700 without PTFE coating directly slides on the test piece 600 results in lower temperatures of the slide surfaces during the sequence of the first and second steps in which the load F applied to the test piece 700 is relatively low. However, the configuration that the aluminum test piece 700 without PTFE coating directly slides on the test piece 600 results in a rapid increase in temperature of the slide surfaces during the sequential steps from the third step S3 in which the load F applied to the aluminum test piece 700 gradually increases. This is because an increase in the amount of heat generated from the slide surfaces with an increase in torque results in rapid increase in the temperature of the slide surfaces.

This temperature increase of the slide surfaces depends on the thermal capacity, i.e., the volume, of the aluminum test piece and/or thermal dissipating surface of the aluminum test piece 700. For this reason, for reducing an increase in temperature of the slide surfaces, it is effective to increase the volume of the aluminum test piece 700 and/or increase a surface area of a portion of the aluminum test piece, which is exposed to atmospheric air.

The third conclusion is that using the aluminum test piece 700 with the slide surface coated with PTFE results in a slight increase in temperature of the slide surfaces as compared to using the aluminum test piece 700 without PTFE coating, because the thermal transfer ratio of the aluminum test piece 700 with the slide surface coated with PTFE is slightly lower than the aluminum test piece 700 without PTFE coating. However, the aluminum test piece 700 with the slide surface coated with PTFE reduces the friction coefficient of the PTFE-coated slide surface to thereby reduce the amount of heat generated therefrom, resulting in the orbiting test comprised of the sequence from the first step S1 to the fourth step S4 being terminated normally.

The inventors therefore have reached, based on the above basis evaluation results, the following conclusion that should be reflected in specific real fluid machines.

Specifically, the fluid machine 1 is configured such that

1. Each of the fixed scroll member 100 and orbiting scroll member 200 is made of a resin material

2. The housing 300, with which the orbiting scroll member 200 is in slidable contact, is made of a material with high thermal conductivity

3. The housing is exposed to atmospheric air

This configuration enables heat generated from the slide portions between the orbiting scroll member 200 and the housing 300 to be diffused, thus dissipating heat from the outer wall of the housing 300. This results in suppression of temperature increase of the plastic orbiting scroll member 200.

Performing predetermined treatment, such as PTFE coating, of the slide surface of the housing 300 to thereby reduce the friction coefficient of the slide surface thereof enables the amount of heat generated from the slide surfaces of the scroll members 100 and 200 even if the scroll members 100 and 200 are used under high load.

If the scroll members 100 and 200 are always used under a load of a predetermined constant value or less, the fluid machine 1 can be configured with no surface treatment, such as coating, applied to the slide surface of the housing 30. This configuration also suppresses temperature increase of the orbiting scroll member 200 and prevents melt-adhesion between the slide surfaces.

The fluid machine 1 described above works to achieve the following beneficial effects.

The fluid machine 1 of the first embodiment is configured such that the orbiting slide surface 230 of the resin orbiting scroll member 200 slides on the housing slide surface 360 of the metallic housing 300. The housing 300 is made of a metal material having a high heat conductivity, and is configured such that the outer wall of the housing 300 is exposed to atmospheric air.

This configuration causes heat generated due to sliding of the orbiting slide surface 230 on the housing slide surface 360 to be diffused through the metallic housing 300 and thereafter to be dissipated from the outer wall of the housing 300 into atmospheric air. This results in suppression of temperature increase due to the sliding of the orbiting slide surface 230 on the housing slide surface 360, making it possible to improve the resistance of the orbiting slide surface 230 and prevents melt-adhesion between the plastic slide surfaces 230 and 360. This therefore improves the reliability of the fluid machine 1.

Using the resin orbiting scroll member 200 enables the weight of the fluid machine 1 to be reduced, making it possible to reduce vibrations of the fluid machine 1 due to orbiting of the orbiting scroll member 200. Using the resin orbiting scroll member 200 also enables the manufacturing cost of the fluid machine 200 to be reduced.

The housing slide surface 360 according to the first embodiment has the coating member 3610 formed thereon; the coating member 3610 is composed of fluorine or molybdenum disulfide, which has self-lubricating characteristics.

The coating member 3610 coated on the housing slide surface 360 enables the frictional coefficient of the housing slide surface 360 to be lower.

The coating member 3610 coated on the housing slide surface 360 is designed as a thin film, making it possible to prevent heat transfer from the orbiting scroll member 200 to the housing 300.

The above experiments show that using the coating member 3610 makes it possible to suppress an increase in temperature of the slidable contact portions, i.e. the slidably contact surfaces 230 and 360, even if the contact surface 230 is slidably contacted with the contact surface 360 under high load to the housing slide surface 360.

Accordingly, the fluid machine 1 including the housing slide surface 360 on which the coating member 3610 is formed is configured to have a higher wear resistance and prevent melt-adhesion between the slide surfaces 230 and 360 even if the fluid machine 1 discharges high-pressure air, making it possible for the fluid machine 1 to have a higher reliability.

The fixed scroll member 100 according to the first embodiment is made of a resin material.

This enables a value of the thermal expansion rate of the fixed scroll member 100 to be substantially equal to a value of the thermal expansion rate of the orbiting scroll member 200. The compression mechanism of the scroll members 100 and 200 has a stable function of compressing air independently of their temperature changes. Using the plastic scroll members 100 and 200 enables the manufacturing cost of the fluid machine 1 to be further reduced.

The scroll members 100 and 200 according to the first embodiment are configured to continuously define the predetermined clearance CL30 between a part of the side surface of the fixed tooth member 120 and the corresponding part of the opposite side surface of the orbiting tooth member 220 while the orbiting scroll member 200 is orbiting; the part of the side surface of the fixed tooth member 120 and the corresponding part of the side surface of the orbiting tooth member 220 are closest to each other while the orbiting wall member 200 is orbiting.

This configuration prevents the orbiting tooth member 220 from sliding on the fixed tooth member 120 even if each of the scroll members 100 and 200 is made of a resin material, thus preventing a temperature increase in each of the respective tooth members 120 and 220, and preventing melt-adhesion between the tooth members 120 and 220. This therefore improves the reliability of the fluid machine 1.

The tip end 1210 of the fixed tooth member 120 according to the first embodiment is located to be closer to the fixed base 110 than the orbiting slide surface 230 and the housing slide surface 360 are.

This arrangement prevents the tip end 1210 of the fixed tooth member 120 from being in contact with the orbiting base 260, thus enabling the orbiting slide surface 230 to slide on the housing slide surface 360 while being reliably in contact with the housing slide surface 360. This reliable contact between the surfaces 230 and 260 during sliding of the surface 230 prevents high-pressure air in the back-pressure chamber 350 from leaking into the low-pressure space 170 located inside of the fixed scroll member 100. The fluid machine 1 accordingly prevents reduction in the compression efficiency of air.

The fluid machine 1 of the first embodiment is configured such that the pressure of the air supplied in the back-pressure chamber 350 causes the orbiting scroll member 200 to be biased toward the fixed scroll member 100, and the orbiting slide surface 230 formed on the first side of the orbiting base 260, which is located closer to the fixed scroll member 100, is in slidable contact with the housing slide surface 360.

Let us assume that a comparative fluid machine includes the orbiting base 260 with the orbiting side surface 230 formed on a second side of the orbiting base 260, which is opposite to the first side of the orbiting base 260 and located farther from the fixed scroll member 100; coating is formed on the housing side surface 360 with which the orbiting side surface 230 is in slidable contact. In this comparative fluid machine, if coating is required for the unillustrated rotation prevention mechanism for preventing rotation of the orbiting scroll member 200, the manufacturing cost of the comparative fluid machine may be increased.

In contrast, the orbiting scroll member 200 of the first embodiment is configured such that the orbiting slide surface 230 is formed on the first side of the orbiting base located to be closer to the fixed scroll member 100. If the coating member 3610 is applied to the housing slide surface 360 with which the orbiting slide surface 203 is in slidable contact, this configuration in which the orbiting slide surface 230 is located to be closer to the fixed scroll member 100 enables the configuration of the fluid machine 1 to be simpler, resulting in the manufacturing cost of the fluid machine 1 being lower.

The housing 300 has the concave recess 370 formed in a radially outer portion of the housing slide surface 360; the concave recess 370 is recessed inwardly in the radially outer portion of the housing slide surface 360 to be away from the orbiting slide surface 230. The concave recess 370 of the housing 300 is in a non-slidable contact with the orbiting slide surface 230 of the orbiting scroll member 200. Designing the concave recess 370 enables the housing slide surface 360 to have the predetermined radial width W. The radial width W of the housing slide surface 360 is set to be smaller than or equal to the double of the eccentric distance E of the orbiting scroll member 200 with respect to the center axis O1 of the revolution of the scroll member 200.

This setting of the radial width W of the housing slide surface 360 sets the slide ratio of the orbiting slide surface 230 to the housing slide surface 360 to be lower than 100%, enabling the orbiting slide surface 230 to intermittently slide on the housing slide surface 360. This therefore reduces the amount of heat generated due to the sliding of the orbiting slide surface 230 on the housing slide surface 360, thus suppressing temperature increase in the slide surfaces 230 and 360.

### Second Embodiment

The following describes the second embodiment. The second embodiment is configured such that a portion of the configuration of the housing 300, the fixed scroll member 100, and the orbiting scroll member 200 is modified as compared to the configuration of the housing 300, the fixed scroll member 100, and the orbiting scroll member 200 according to the first embodiment. The following therefore describes only the modified portion of the second embodiment, because the remaining portion of the second embodiment is substantially identical to the corresponding portion of the first embodiment.

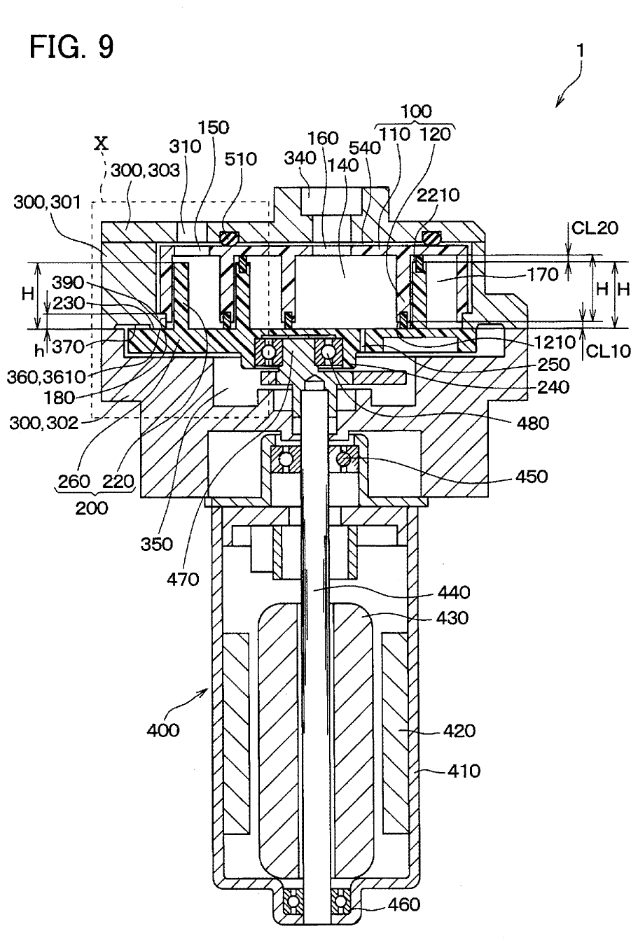

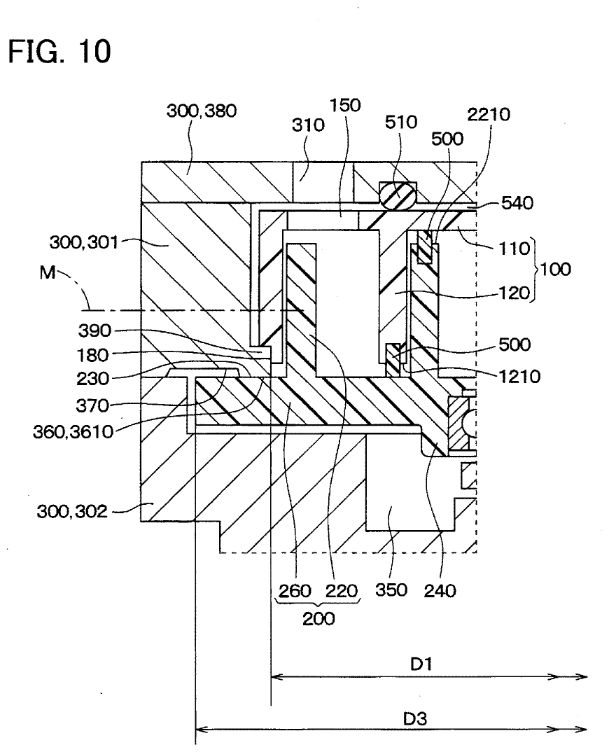

Referring to FIGS. 9 and 10, the housing 300 of the second embodiment is comprised of the first housing 301, the second housing 302, and a third housing 303. Each of the first and second housings 301 and 302 is made of a metal material, such as aluminum, with a high heat conductivity.

Each of the second and third housings 302 and 303 has no housing slide surfaces, and therefore can be made of another material, such as plastic. Each of the first to third housings 301 to 303 is made of a metal material, making it possible to further improve the heat dissipating ability of the fluid machine 1 of the second embodiment. The first to third housings 301 to 303 are fixedly assembled to each other with unillustrated bolts or fixedly welded to each other.

The fixed tooth member 120 of the fixed scroll member 100 of the second embodiment has a notched groove 180 formed in a radially outer portion thereof; the radially outer portion of the fixed tooth member 120 is located to be adjacent to the orbiting base 260. The notched groove 180 is radially inwardly intended.

The first housing 301 has an overhang portion 390 formed to be fitted in the notched groove 180 of the fixed scroll member 100. The inner wall of the overhang portion 390, which is located to be radially inside thereof, are pressed to be fitted in the outer wall of the fixed scroll member 100, which is located radially outside thereof.

The fixed base 110 has opposing first and second surfaces; the first surface being closer to the orbiting base 260 than the second surface is.

The fixed portion between the first housing 301 and the fixed scroll member 100, i.e. fitted portion therebetween, according to the second embodiment is located to be closer to the orbiting base 260 than a middle portion M; the middle portion M is defined as a middle portion between the housing slide surface 360 and the first surface of the fixed base 110, which is closer to the orbiting base 260 than the opposite second surface thereof is. The overhang portion 390 has a height h in the axial direction of the first housing 301, which is shorter than the height H of the orbiting tooth member 220.

This configuration enables the fixed scroll member 100 to extend to be away from the housing slide surface 360 even if the fixed scroll member 100 thermally expands due to its temperature change. This enables the orbiting slide surface 230 to reliably slide on the housing slide surface 360 while preventing the tip end 1210 of the fixed tooth member 120 from being contacted with the orbiting base 260. This prevents high-pressure air in the back-pressure chamber 350 from leaking into the low-pressure space 170 located inside of the fixed scroll member 100. The above configured liquid machine 1 of the second embodiment therefore prevents a reduction in the compression efficiency of air.

In the second embodiment, an 0 ring 510, which serves as a biasing member and a seal member, is disposed between the fixed base 110 of the fixed scroll member 100 and the third housing 300. That is, the 0 ring 510 serves as an example of a biasing member. The 0 ring 510 is configured to bias the fixed scroll member 100 toward the orbiting scroll member 200 to thereby cause an axial contact surface of the notched groove 180 of the fixed scroll member 100 to be in contact with an axial contact surface of the overhang portion 390. This enables the posture of the fixed scroll member 100 to be stable even if the fluid machine 1 of the second embodiment is deactivated.

In addition, the third housing 303 has the discharge port 340 formed thereon, and the 0 ring 510 is arranged to surround the discharge port 340 of the third housing 303. That is, the 0 ring 510, which has formed a space 540 located at a radially inner side thereof, is arranged to surround the discharge hole 160 of the fixed scroll member 100. This arrangement of the 0 ring 510 enables, when the fluid machine 1 is activated, high-pressure air from the discharge hole 160 to be supplied to the space 540 defined in the 0 ring 510. This enables the pressure of the high-pressure air in the space 540 to bias the fixed base 110 toward the orbiting scroll member 200, resulting in the axial contact surface of the notched groove 180 of the fixed scroll member 100 to abut on the axial contact surface of the overhand portion 390.

The overhang portion 390 of the second embodiment has a surface that faces the orbiting slide surface 360; the surface of the overhang portion 390, which faces the orbiting slide surface 360, constitutes the housing slide surface 360.

The housing slide surface 360 of the second embodiment is therefore configured to have an inner radius D1, which is illustrated in FIG. 10, being smaller than an inner diameter D2 of the housing slide surface 360 of the first embodiment, which is illustrated in FIG. 2. This configuration according to the second embodiment illustrated in FIG. 10 therefore enables an outer diameter D3 of the orbiting base 260, which has the orbiting slide surface 230 slidable on the housing slide surface 360, to be shorter than an outer diameter D4 of the orbiting slide surface 230 of the above configuration according to the first embodiment illustrated in FIG. 2.

This therefore results in the fluid machine 1 of the second embodiment having an axial size smaller than an axial size of the fluid machine 1 of the first embodiment.

The working and achieved beneficial effects of the second embodiment are substantially identical to the working and achieved beneficial effects of the first embodiment.

### Third Embodiment

The following describes the third embodiment. The third embodiment is configured such that a portion of the configuration of the first housing 310 is modified as compared to the configuration of the first housing 301 according to the first embodiment. The following therefore describes only the modified portion of the second embodiment, because the remaining portion of the third embodiment is substantially identical to the corresponding portion of the first embodiment.

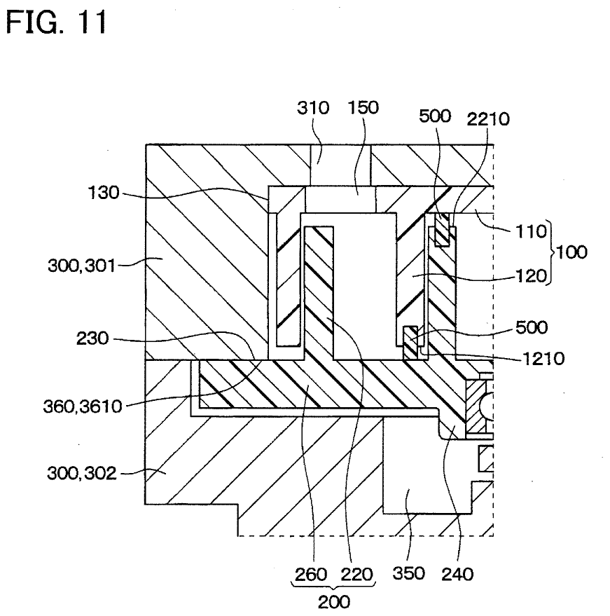

Referring to FIG. 11, the first housing 301 of the third embodiment has no concave recess 370 formed in a radially outer portion of the housing slide surface 360. For this reason, the orbiting slide surface 230 is configured to continuously slide on the housing slide surface 360 without intermittently sliding thereon. That is, this configuration enables the slide ratio of the orbiting slide surface 230 to the housing slide surface 360 to be set to 100%. This configuration also enables heat generated from the slide surfaces 230 and 360 to be diffused, thus dissipating heat from the outer wall of the housing 300. This results in suppression of temperature increase of the plastic orbiting scroll member 200, making it possible to improve the resistance of the orbiting slide surface 230 and prevent melt-adhesion between the plastic slide surfaces 230 and 360. This therefore improves the reliability of the fluid machine 1 of the third embodiment.

### Fourth Embodiment

The following describes the fourth embodiment. The fourth embodiment is configured such that a portion of the slide portions of the fourth embodiment is modified as compared to the slide portions of the first embodiment. The following therefore describes only the modified portion of the fourth embodiment, because the remaining portion of the fourth embodiment is substantially identical to the corresponding portion of the first embodiment.

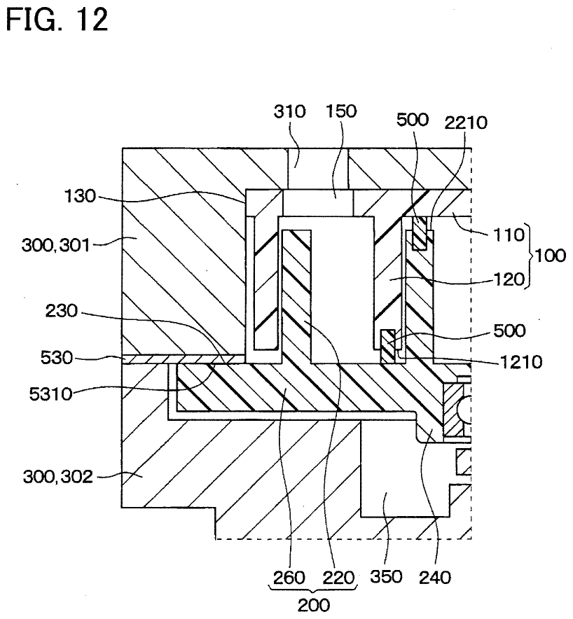

In the fourth embodiment, as illustrated in FIG. 12, a spacer 530 is provided between the first housing 301 and the second housing 302. Specifically, the spacer 530 is disposed between the orbiting slide surface 230 of the orbiting scroll member 200 and a portion of the first housing 301; the portion of the first housing 301 faces the orbiting slide surface 230. The spacer 530 is made of a metal material, such as aluminum or iron. The spacer 530 has a surface with which the orbiting slide surface 230 is in slidable contact, and the surface of the spacer 530 has a coating member 5310 formed thereon; the coating member 5310 is composed of fluorine or molybdenum disulfide, which has self-lubricating characteristics. As the fluorine coating, polytetrafluoroethylene (PTFE) coating can be preferably used.

Applying the coating member 5310 to the metallic spacer 530 without applying coating to the first housing 301 or the second housing 302, which has larger in size than the metallic spacer 530 enables the load required to perform the coating-member applying process according to the fourth embodiment to be smaller than that required to perform the coating-member applying process according to the first embodiment. This therefore enables the manufacturing cost of the fluid machine 1 of the fourth embodiment to be lower.

The working and achieved beneficial effects of the fourth embodiment are substantially identical to the working and achieved beneficial effects of the first embodiment.

### Fifth Embodiment

The following describes the fifth embodiment. The fifth embodiment is configured such that a portion of the slide portions of the fifth embodiment is modified as compared to the slide portions of the first embodiment. The following therefore describes only the modified portion of the fifth embodiment, because the remaining portion of the fifth embodiment is substantially identical to the corresponding portion of the first embodiment.

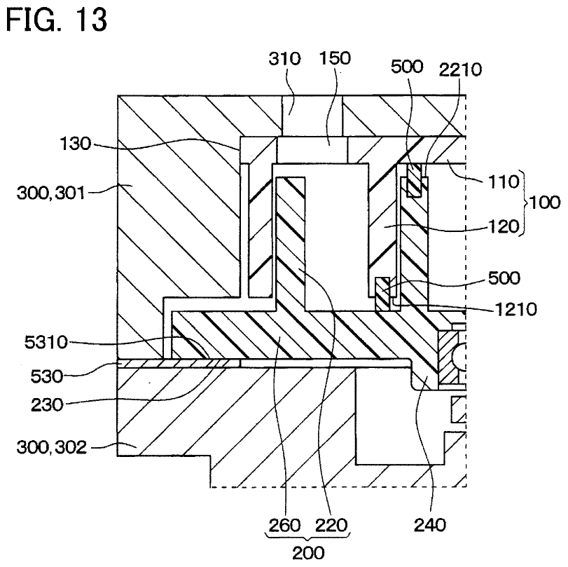

In the fifth embodiment, as illustrated in FIG. 13, a spacer 530 is provided between the orbiting slide surface 230 of the orbiting scroll member 200 and a portion of the second housing 302; the portion of the second housing 302 faces the orbiting slide surface 230. The orbiting slide surface 230 of the orbiting scroll member 200 is formed on the second side of the orbiting base 260, which is opposite to the first side of the orbiting base 260; the first side is located closer to the fixed scroll member 100.

Note that the orbiting scroll member 200 of the fifth embodiment has no back-pressure holes 250 formed through the orbiting base 260 although this structure is not illustrated in FIG. 13. For this reason, no high-pressure air is supplied to the space between the second side of the orbiting base 260 and the inner wall of the second housing 302. That is, the space defined between the second side of the orbiting base 260 and the inner wall of the second housing 302 does not serve as a back-pressure chamber 350. This therefore causes the pressure of air in the compression chambers 140 to urge the orbiting base 260 of the orbiting scroll member 200 toward the spacer 530.

The orbiting base 260 urged toward the spacer 530 enables the orbiting slide surface 230 formed on the second side of the orbiting base 260 to slide on the spacer 530. The spacer 530 is shaped to have a ring, and made of a metal material, such as aluminum. The spacer 530 has a surface with which the orbiting slide surface 230 is in slidable contact, and the surface of the spacer 530 has a coating member 5310 formed thereon; the coating member 5310 has self-lubricating characteristics.

The working and achieved beneficial effects of the fifth embodiment are substantially identical to the working and achieved beneficial effects of the first embodiment.

### Sixth Embodiment

The following describes the sixth embodiment that discloses an example of a fluid machine. The fluid machine 1 of the sixth embodiment, which is able to achieve an object disclosed in the specification, includes a machine for compressing fluid or an apparatus for expanding fluid. The fluid machine 1 of the sixth embodiment is capable of compressing or expanding liquid, gas, or gas-liquid mixture fluid, which is used as working fluid, and thereafter discharging the compressed or expanded liquid, gas, or gas-liquid mixture fluid to the outside thereof. For example, air, water, or one of various types of coolants can be used as the working fluid.

The fluid machine 1 is designed as a scroll-type fluid machine used without lubricant oil; the fluid machine 1 is comprised of a fixed scroll member 33 and an orbiting scroll member 20; at least the orbiting scroll member 20 is made of a resin material.

The fluid machine 1 of the sixth embodiment, which is configured to be used without lubricant oil, eliminates the need of providing accessories, such as oil separators. The fluid machine 1 is used as an air compressor that supplies clean air, such as medical air or industrial air.

The following describes the configuration of the fluid machine 1.

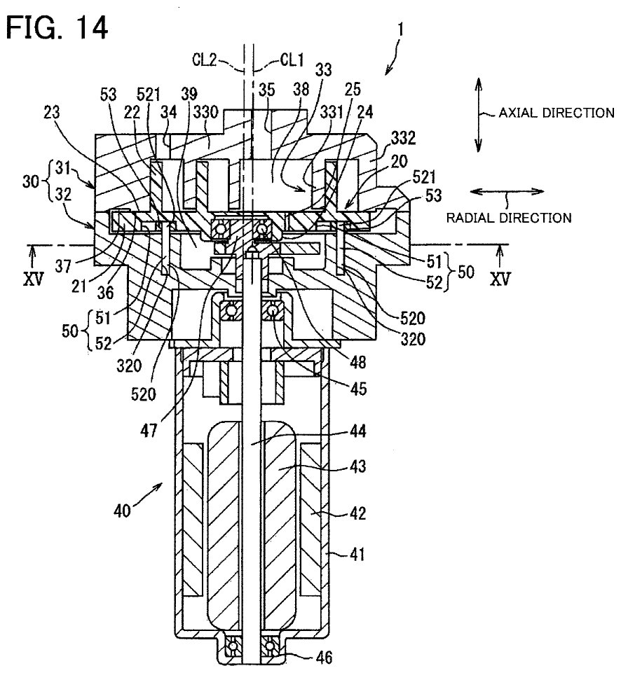

As illustrated in FIG. 14, the fluid machine 1 of the sixth embodiment is comprised of a housing 30, the fixed scroll member 33 described above, the orbiting scroll member 20 described above, and a motor unit 40.

The housing 30 is comprised of a first housing 31 and a second housing 32. Each of the first and second housings 31 and 32 serves as a fixed member located stationary as compared to the movable orbiting scroll member 20. Each of the first and second housings 31 and 32 is made of a metal material, such as aluminum, with a high heat conductivity. The first and second housings 31 and 32 are fixedly assembled to each other with unillustrated bolts or fixedly welded to each other. Each of the first and second housings 31 and 32 is arranged such that a part of the corresponding one of the first and second housings 31 and 32 is exposed to atmospheric air.

The housing 30 is configured to house the fixed scroll member 33 and the orbiting scroll member 20.

The fixed scroll member 33 is configured as a part of the first housing 31. That is, the fixed scroll member 33 and the first housing 31 constitute an assembly. The following also describes the fixed scroll member 33 and the orbiting scroll member 20 simply as scroll members 33 and 20.

The scroll members 33 and 20 are configured as a compressing unit that sucks air, compresses the sucked air, and discharge the compressed air.

The fixed scroll member 33 is comprised of a base 330 having a substantially discotic shape, and a fixed tooth member 331 projecting from the base 330. The fixed tooth member 331 is designed as a fixed wrap member constituting the fixed scroll member 33 to have a spiral shape when the fixed scroll 33 is seen in the axial direction thereof.

The base 330 has an outer circumferential edge, and has a tubular cylindrical wall 332 formed on the outer circumferential edge. The tubular cylindrical wall 332 of the first housing 31 is joined to the second housing 32.

As illustrated in FIG. 14, the tubular cylindrical wall 332 is shaped to axially project from the outer circumferential edge of the base 330 to surround the base 330.

The fixed scroll member 33 and the orbiting scroll member 20 define compression chambers 38 therebetween. The base 330 of the fixed scroll member 33 has a suction port 34 formed therethrough for enabling air to be supplied therethrough into each of the compression chambers 38. The base 330 of the fixed scroll member 33 also has a discharge port 35 formed therethrough for discharging air stored in each of the compression chambers 38 out of the compression chamber 38.

The orbiting scroll member 20 is comprised of a base 21 having a substantially discotic shape, and an orbiting tooth member 22 disposed on the base 21. The orbiting tooth member 22 is designed as an orbiting wrap member mounted on the base 21 to have a spiral shape when the orbiting scroll member 20 is seen in the axial direction thereof.

Each of the compression chambers 38 mounted on a first side of the base 21 serves as a fluid chamber configured to suck fluid thereinto, compress the sucked fluid, and discharge the compressed fluid therefrom. Each of the compression chambers 38 has a crescent shape as seen from the axial direction of the scroll members 100 and 200.

A cylindrical boss member 24 is mounted on a second side of the base 21, which is opposite to the first side thereof.

The fixed tooth member 331 has a predetermined first spiral configuration with a predetermined first wrap angle range, and the orbiting tooth member 22 also has a predetermined second spiral configuration with a predetermined second wrap angle range. The first and second spiral configurations are asymmetric to each other, and the first and second wrap angle ranges are set to be different from each other. It is preferable that the absolute difference between the first and second wrap angle ranges is set to be no less than 30 degrees. The asymmetric assembly of the tooth members 331 and 22 enables an inner space defined by the tooth members 331 and 22 and an outer space defined thereby to be efficiently used, making it possible for the fluid machine 1 to have a compact size with a sufficient suction volume.

The fixed tooth member 331 is comprised of an extending spiral portion located to be radially outside of a radially outer portion of the orbiting tooth member 22. The extending spiral portion of the fixed tooth member 331 is mounted to the tubular cylindrical wall 332. The extending spiral portion of the fixed tooth member 331 mounted to the tubular cylindrical wall 332 preferably results in the wrap angle rage of the fixed tooth member 331 being larger by a given gap angle than the orbiting tooth member 22; the gap angle is for example set to an angle selected from the angular range from 170 degrees to 190 degrees inclusive.

If the fluid machine 1 of the sixth embodiment is designed as an expander for expanding fluid, the fluid machine 1 is configured such that each fluid chamber is movable from the center of the fixed scroll 33 toward the outer circumferential edge thereof. In the expander, the suction port 34 serves as a discharge port, and the discharge port 35 serves as a suction port. That is, each fluid chamber is adapted to expand to increase the volume thereof, resulting in fluid sucked in each fluid chamber from its center portion expanding.

Because the orbiting scroll member 20 is made of a resin material to have a relatively small specific gravity, it is possible to reduce vibrations thereof due to centrifugal force.

As illustrated in FIGS. 14 and 15, the fluid machine 1 includes four rotation prevention mechanisms 50 for preventing rotation of the orbiting scroll member 20.

Each of the rotation prevention mechanisms 50 is comprised of a hollow restricting portion 51 with a circular inner peripheral wall, and a projection 52, and a ring-shaped intervening member 53. The projection 52 is configured to orbit inside the restricting portion 51 while being restricted by the inner peripheral wall of the restricting portion 51. The intervening member 53 is located to intervene between the projection 52 and the inner peripheral wall of the restricting portion 51.

The four rotation preventing members 50 are arranged around the center axis of the orbiting scroll member 20 with substantially regular intervals. The substantially regular intervals among the four rotation prevention mechanisms 50 include equal intervals and a case where at least one interval is deviated from the equal intervals within a predetermined dimension tolerance. For example, the predetermined dimension tolerance is set to ±5 degrees.

The fluid machine 1 can be equipped with three rotation prevention mechanism 50 or five or more rotation prevention mechanisms 50.

The restricting portion 51 is configured as a hole or a bottomed hole, i.e. a recess, defined by the circular inner peripheral wall thereof. For example, the restricting portion 51 is configured as a recess formed in the second side of the base 21 of the orbiting scroll member 20; the bottomed recess has a predetermined depth. The second housing 32 has an end surface that is orthogonal to the center axis CL1 thereof, and the restricting portion 51 is located to face the end surface of the second housing 32. The restricting portion 51 is comprised of the inner peripheral wall with opposite circular opening ends, and a bottom that closes one of the opposite circular openings; the closed circular opening is located to be closer to the fixed scroll member 33 than the other thereof is. The inner peripheral wall and the bottom, which define the recess, constitute a part of the base 21.

The projection 52 has a pin-shaped member comprised of a fixture base 520 and a slide portion 521 extending from the fixture base 520 to project toward the bottom of the restricting portion 51. The projection 52 is made of iron or an alloy of metal. The projection 52 can be called as a pin. The second housing 32 has a cylindrical recess 320, and the fixture base 520 is pressed to be fixedly fitted in the cylindrical recess 320. The projection 52 is fixed to the second housing 32 while the bottom of the restricting portion 51 is separated from a tip end of the slide portion 521 and a tip end of the intervening member 53.

The intervening member 53 is rotatably mounted around the outer periphery of the projection 52. That is, each rotation prevention mechanism 50 includes the intervening member 53 rotatable with respect to the pin-shaped projection 52. The slide portion 521 is configured to slide, through the intervening member 53, on the inner peripheral wall of the restricting portion 51 while being restricted by the restricting portion 51. The slide portion 521 and the intervening member 53 of each rotation projecting mechanism 50 constitute a slide mechanism that is configured to slide on the inner peripheral wall of the restricting portion 51 while being restricted by the inner peripheral wall of the restricting portion 51.

The intervening member 53 is made of, for example, metal. In association with orbiting of the orbiting scroll member 20, the intervening member 53 is configured to orbit inside the restricting portion 51 while rotating with respect to the pin-shaped projection 52 and being restricted by the inner peripheral wall of the restricting portion 51.

The properties of the material of the intervening member 53 include surface hardness lower than that of the material of the projection 52. That is, the material of the intervening member 53 is likely to be worn as compared to the material of the projection 52, and the projection 52 has surface roughness lower than that of the inner peripheral surface of the intervening member.

While the orbiting scroll member 20 is orbiting, the outer periphery of the projection 52 and the inner periphery of the intervening member 53 slide on each other. At that time, the above configuration of the projection 52 and intervening member 53 will therefore result in the intervening member 53 being more easily worn than the projection 52. The inner surface of the intervening member 53 will be worn so as to conform to the smaller surface roughness of the outer peripheral surface of the projection 52. This will result in the surface resistance of each of the projection 52 and the intervening member 53 becoming small. This therefore prevents excessive wearing of the intervening member 53.

For example, the surface hardness of each of the intervening member 53 and the slide portion 521 can be for example measured in accordance with JIS Z 2244 of Vickers hardness test.

The intervening member 53 is preferably made of a metal material containing copper and/or tin. Because metal containing copper and/or tin has solid lubricating effect, the intervening member 53 made of a metal material containing copper and/or tin enables the slide portions of the fluid machine 1 without lubricating oil to be reduced. The intervening member 53 can be composed of metal containing iron.

The intervening member 53 is preferably comprised of an oil-bearing porous body, which makes it possible to reduce the wearing of the intervening member 53 based on lubricating effect of oil maintained in the porous body even if the fluid machine 1 works without lubricating oil.

For example, the porous body constituting the intervening member 53 is a sintered metallic porous body or a sintered plastic porous body. Such a sintered metallic porous body can be made of powdery metal that has been sintered at temperature equal to its melting point or thereabout. Powdery iron, powdery copper, powdery aluminum or powdery magnesium can be used as the powdery metal. Sintering powdery plastic and thereafter forming the sintered powdery plastic into a desired shape enable such a plastic-sintered porous body to be manufactured. The intervening member 53 can be preferably contain a solid lubricant agent, such as molybdenum dioxide, graphite, organomolybdenum compound, or fluorine compound.

The intervening member 53 is preferably made of a metal material containing copper and/or tin, and also preferably contains solid lubricant agent.

The intervening member 53, which has a first end 53a and a second end opposite to the first end 53a in an axial direction thereof. The first end 53a of the intervening member 53 and an inner surface 51a of the bottom, i.e. a bottom surface, of the restricting portion 51 are arranged to be separated from each other. The first end 53a of the intervening member 53 serves as an end surface thereof; the end surface of the intervening member 53 is located to be closer to the fluid chamber or fixed scroll member 33 than the second end is, and is perpendicular to the axial direction of the intervening member 53.

The slide portion 521 and the intervening member 53 slidably move along the inner peripheral wall of the restricting portion 51 when the orbiting scroll member 20 is orbiting.

The fixture base 520 constituting a first end of the projection 52 is supported to the second housing 32 serving as a fixed member. The projection 52 also has a second end opposite to the first end, and the slide portion 521 constitutes the second end of the projection 52. The slide portion 521 and the intervening member 53 mounted thereto are supported to the orbiting scroll member 20 serving as a movable member. Specifically, the fixture base 520 at the first end of the projection 52 is fixed to the fixed member, and the slide portion 521 and the intervening member 53 at the second end of the projection 52 are slidably supported to the restricting portion 51.

The second housing 32 has opposing first and second sides. The first side of the second housing 32 is located to be closer to the first housing 31 than the second side is.

A motor unit 40 is provided at the second side of the second housing 32. The motor unit 40 includes a motor case 41, a stator 42, a rotor 43, and a shaft 44; these components 42, 43, and 44 are installed in the motor case 41. A selected one of various types of motors, such as a brush motor or a brushless motor, can be used as the motor unit 40. The shaft 44 is mounted to the motor case 41 via bearings 45 and 46 installed in the motor case 41 so as to be rotatable.

The shaft 44 is rotated by the motor unit 40. The shaft 44 has opposing first and second ends. The first end of the shaft 44 is disposed in the second housing 32. An eccentric member 47 is fixed to the first end of the shaft 44. The eccentric member 47, which has a center axis CL2, is located such that the center axis CL2 is eccentrically arranged from the center axis CL1 of the shaft 44. The eccentric member 47 is provided in the boss portion 24 via a bearing 48.

When the motor unit 40 is energized, the shaft 40 is rotated around the center axis CL1, so that the motor unit 40 outputs torque. The torque outputted from the motor unit 44 is transferred to the boss portion 24 of the orbiting scroll member 20 via the eccentric member 47. The torque transferred to the orbiting scroll member 20 from the eccentric member 47 causes the orbiting scroll member 20 to orbit around the center axis CL1 of the shaft 44 while rotation of the orbiting scroll member 20 is prevented by the rotation prevention mechanisms 50 each including the intervening member 53.

The radius of the orbiting of the orbiting scroll member 20 is substantially identical to the minimum distance between the center axis CL1 and the center axis CL2. While the orbiting scroll member 20 is orbiting, the orbiting scroll member 20 and the rotation prevention mechanism 50 are subjected to centrifugal force.

Orbiting of the orbiting scroll member 20 causes each of the compression chambers 38 formed between the scroll members 33 and 20 to pivotally move from the radially outer side to the radially inner side.

Each compression chamber 38 located to be closer to the suction port 34 changes to approach the rotation axis CL1 or the discharge port 35 while the volume of the corresponding compression chamber 38 being gradually reduced. This gradual reduction of the volume of each of the compression chambers 38 causes air supplied from the suction port 34 into the corresponding one of the compression chambers 38 to be compressed, and the compressed air in each compression chamber 38 is discharged from the discharge port 35 out of the fluid machine 1.

The second side of the base 21 and a separate wall 321 of the second housing 2, i.e. the inner wall of the second housing 32, which is closer to the center axis CL1, provide a back-pressure chamber 39 therebetween. Into the back-pressure chamber 39, a part of the air compressed by the compression chambers 38 is supplied via a back-pressure introduction hole 25 formed through the base 21. The pressure of the air supplied in the back-pressure chamber 39 causes the orbiting scroll member 20 to be biased toward the fixed scroll member 33.

The outer portion of the base 21 has an orbiting slide surface 23, and the first housing 31 includes a portion that faces the orbiting slide surface 230. Specifically, the portion of the first housing 31 has a housing slide surface 36 that is in slidable contact with the orbiting slide surface 23.

Pressure of air stored in the back-pressure chamber 39 biases the orbiting scroll member 20 toward the fixed scroll member 33 when the orbiting scroll member 20 orbits. This biasing causes the orbiting slide surface 23 to slide while the orbiting slide surface 23 is constantly contacted with the housing slide surface 36. This results in the housing slide surface 36 serving as a thrust bearing that is subjected to an axial load of the orbiting scroll member 20. That is, the orbiting scroll member 20 orbits while being supported by the housing slide surface 36 serving as the thrust bearing.

If there were a clearance between the orbiting slide surface 23 and the housing slide surface 36, high-pressure air supplied from the compression chambers 38 to the back-pressure chamber 39 would pass through the clearance to leak into a low-pressure space located inside of the fixed scroll member 33.

In contrast, the biasing of the orbiting scroll member 20 toward the fixed scroll member 33 based on the pressure of air stored in the back-pressure chamber 39 according to the sixth embodiment enables the orbiting slide surface 23 to slide while the orbiting slide surface 23 is reliably contacted with the housing slide surface 36. This prevents high-pressure air in the back-pressure chamber 39 from leaking into the low-pressure space located inside of the fixed scroll member 33. The above configured fluid machine 1 of the sixth embodiment therefore prevents a reduction in the compression efficiency of air.

The housing slide surface 36 preferably has a coating member formed thereon; the coating member is composed of fluorine or molybdenum disulfide, which has self-lubricating characteristics. The coating member coated on the housing slide surface 36 enables the frictional coefficient of the housing slide surface 36 to be lower. As the fluorine coating, polytetrafluoroethylene (PTFE) coating can be preferably used.

The coating member coated on the housing slide surface 360 is designed as a thin film, making it possible to maintain heat transfer from the orbiting scroll member 20 to the housing 30. This therefore suppresses an increase in temperature of the slidable contact portions, i.e. the slidably contact surfaces 23 and 36, even if the contact surface 23 is slidably contacted with the contact surface 36 under high load to the housing slide surface 36.

The first housing 31 has a concave recess 37 formed in a radially outer portion of the housing slide surface 36. The concave recess 37 is dented inwardly in the radially outer portion of the housing slide surface 36 to be away from the orbiting slide surface 23. The concave recess 37 of the first housing 31 is in a non-slidable contact with the orbiting slide surface 23 of the orbiting scroll member 20.

A tip end of the fixed tooth member 331 and the orbiting base 21 of the orbiting scroll member 33 define a predetermined clearance therebetween. In addition, a tip end of the orbiting tooth member 22 and the base 330 of the fixed scroll member 33 define a predetermined clearance therebetween. This results in the tip end of the fixed tooth member 31 being located to be closer to the base 330 than the orbiting slide surface 23 and the housing slide surface 36 are. This arrangement enables the orbiting slide surface 23 to slide on the housing slide surface 36 while being reliably in contact with the housing slide surface 36. This reliable contact between the surfaces 23 and 36 during sliding of the surface 23 prevents highly-pressurized air in the back-pressure chamber 39 to leak into the low-pressure space located inside of the fixed scroll member 33.

The sixth embodiment is configured such that torque outputted from the motor unit 40 causes the orbiting scroll member 20 to orbit, and orbiting of the orbiting scroll member 20 causes the orbiting slide surface 23 to slide on the housing slide surface 36. Heat generated due to the slide of the orbiting slide surface 23 on the housing slide surface 36 is diffused through the first and second housings 31 and 32 without staying at the surfaces 23 and 36 and thereafter is discharged from the outer walls of the housing 31 and 32. This reduces an increase in the temperature of the orbiting slide surface 23 and housing slide surface 36 due to the slide of the surface 23 on the surface 36, making it possible to improve the resistance of the orbiting slide surface 23 and prevents melt-adhesion between the plastic slide surfaces.

The fluid machine 1 according to the sixth embodiment described above works to achieve the following beneficial effects.

The fluid machine 1 of the sixth embodiment includes the fixed scroll member 33 comprised of the fixed wrap member, and the orbiting scroll member 20 comprised of the orbiting wrap member; the orbiting wrap member and the fixed wrap member define a fluid chamber in which fluid sucked in the fluid chamber is compressed to be discharged from the fluid chamber.

The fluid machine 1 also includes the rotation prevention mechanisms 50 arranged with substantially regular intervals. Each rotation prevention mechanism 50 is comprised of the hollow restricting portion 51 with the circular inner peripheral wall, the projection 52, and the intervening member 53. The projection 52 is configured to orbit inside the restricting portion 51 while being restricted by the inner peripheral wall of the restricting portion 51. The intervening member 53 is located to intervene between the projection 52 and the inner peripheral wall of the restricting portion 51.

The intervening member 53 is made of a material having surface hardness smaller than that of the projection 52, and the projection 52 has surface roughness smaller than that of the inner peripheral portion of the intervening member 53. The reason why the surface roughness of the projection 52 is set to be smaller than that of the inner peripheral portion of the intervening member 53 is that the outer peripheral surface of the projection 52 is more easily treated than the inner peripheral surface of the intervening member 53, so that the surface roughness of the projection 52 is more easily reduced as compares with the surface roughness of the inner peripheral wall of the intervening member 53.

Because the surface hardness of the intervening member 53 is smaller than that of the projection 52, the inner peripheral portion of the intervening member 53 will be more easily worn than the outer peripheral portion of the projection 52 so as to confirm to the projection 52 with the smaller surface roughness. If the slide portion of the intervening member 53 conforms sufficiently to the slide portion of the projection 52, the surface resistance between the projection 52 and the intervening member 53 will become small. This therefore reduces wearing of the intervening member 53 and the projection 52, and inhibits seizing between the intervening member 53 and the projection 52.

The fluid machine 1 includes the intervening member 53 made of a metal material containing copper and/or tin. The solid lubricating effect of the metal prevents excessive wearing of the intervening member 53 and the slide portion 521 even if the fluid machine works without lubricating oil, thus reducing wearing of the intervening member 53 and the slide portion 521, and inhibiting seizing between the intervening member 53 and the slide portion 521.

The fluid machine 1 includes the intervening member 53 comprised of an oil-bearing porous body. This makes it possible to reduce excessive wearing of the intervening member 53 and the slide portion 521 based on lubricating effect of oil maintained in the porous body even if the fluid machine 1 works without lubricating oil, thus reducing wearing of the intervening member 53 and the slide portion 521, and inhibiting seizing between the intervening member 53 and the slide portion 521.

The fluid machine 1 includes the intervening member 53 containing solid lubricant agent, resulting in a friction coefficient between the intervening member 53 and the slide portion 521 being smaller. This therefore reduces wearing of the intervening member 53 and the slide portion 521, and inhibits seizing between the intervening member 53 and the slide portion 521.

The intervening member 53 is shaped to have a ratio of the outer diameter dimension to the inner diameter dimension, which is set to be more than or equal to 2. This enables the ratio of the outer peripheral slide resistance to the inner peripheral slide resistance to be larger to thereby reduce slip between the intervening member 53 and the inner peripheral wall of the restricting portion 51. This therefore enables the intervening member 53 to be likely to turn on the inner peripheral wall of the restricting portion 51, thus reducing wearing of the intervening member 53 and the slide portion 521, and inhibiting seizing between the intervening member 53 and the slide portion 521.

The inner peripheral wall of the restricting portion 51 constitutes the orbiting scroll member 20 that is made of a fiber-reinforced resin material. This configuration including the orbiting scroll member 20 made of a resin material whose specific gravity is relatively small provides the fluid machine 1 with smaller vibrations. Using a fiber-reinforced plastic as a material of the orbiting scroll member 20 enables plastic deformation, abnormal wearing, and/or agglutination of the inner peripheral wall of the restricting portion 51 to be reduced. A fiber-reinforced plastic is a plastic material containing glass fiber and/or a talc material.

### Seventh Embodiment

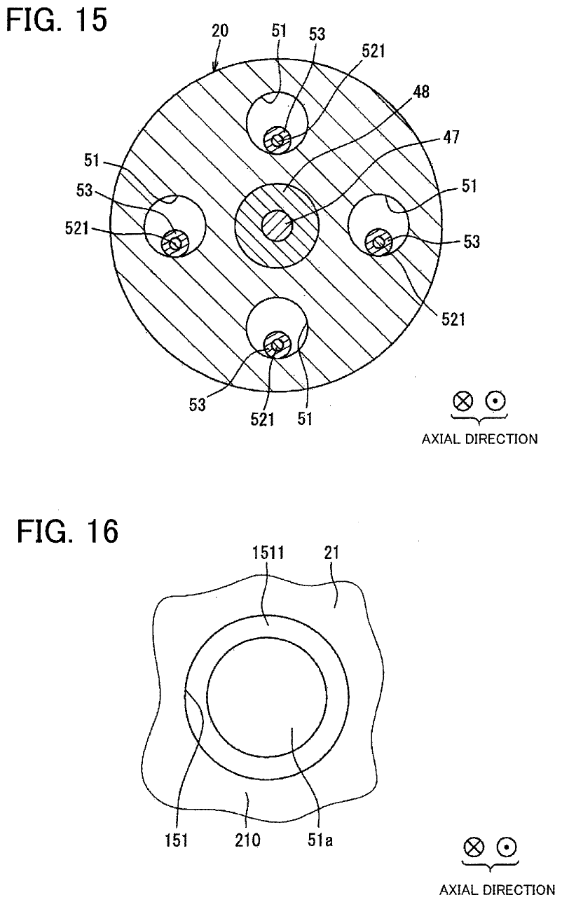

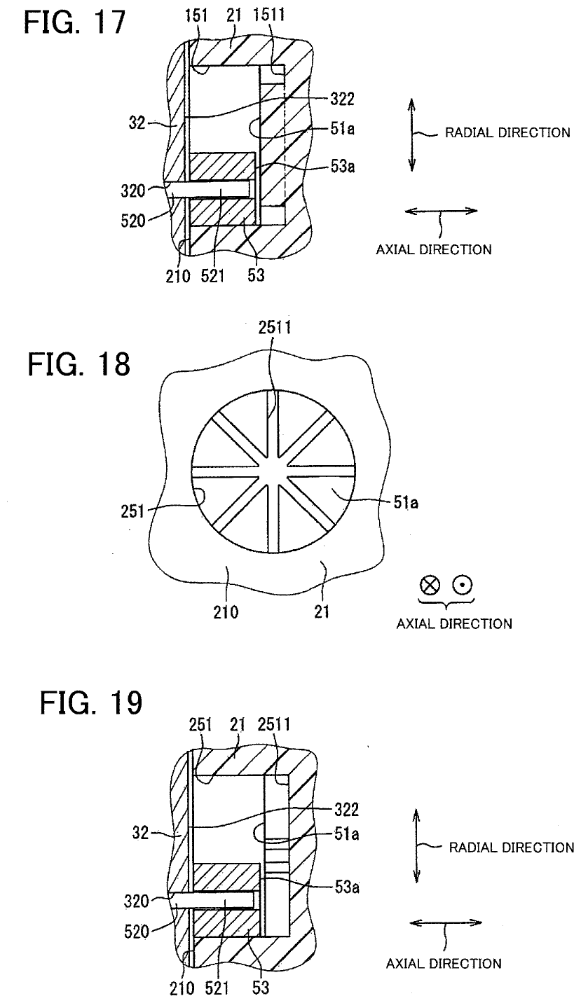

The following describes the seventh embodiment with reference to FIGS. 16 and 17. The seventh embodiment is configured such that the configuration of each restricting portion 151 of the seventh embodiment is modified as compared to that of the sixth embodiment. The following therefore describes only the modified portion of the seventh embodiment, because the remaining portion of the seventh embodiment is substantially identical to the corresponding portion of the sixth embodiment.

Referring to FIGS. 16 and 17, the restricting portion 151 is comprised of the aforementioned recess with the inner surface 51a and a partial concave groove 1511 that is further deeply dented in the second side of the base 21 toward the fluid chamber relative to the inner surface 51a of the bottom that the first end 53a of the intervening member 53 faces. The partial concave groove 1511 is shaped as a circular annular groove disposed around the outer peripheral edge of the inner surface 51a of the bottom. The partial concave groove 1511 can be shaped to have a circular arc located adjacent to at least one part of the outer peripheral edge of the inner surface 51a of the bottom. That is, the partial concave groove 1511 can be comprised of at least one circular-arc groove disposed adjacent to at least one part of the outer peripheral edge of the inner surface 51a of the bottom.

The restricting portion 151 of the seventh embodiment is comprised of the inner surface 51a of the bottom that the first end 53a of the intervening member 53 faces, and the partial concave groove 1511 dented relative to the inner surface 51a of the bottom so as to be far away from the intervening member 53. This configuration enables oil that seeps from, for example, the intervening member 53, which may contain worn powder, to be stored in the partial concave groove 1511. This prevents one or more slide members, such as the intervening member 53, the orbiting scroll member 20, or the other components, from becoming an abnormal wearing state. The partial concave groove 1511 improves the amount of recovery of oil and/or foreign materials around the inner peripheral wall of the restricting portion 151, thus improving the recovery performance of the fluid machine 1 for abnormal materials that move toward the inner peripheral wall of the restricting portion 151 by centrifugal force.

### Eighth Embodiment

The following describes the eighth embodiment with reference to FIGS. 18 and 19. The eighth embodiment is configured such that the configuration of each restricting portion 251 of the eighth embodiment is modified as compared to that of the sixth embodiment. The following therefore describes only the modified portion of the eighth embodiment, because the remaining portion of the eighth embodiment is substantially identical to the corresponding portion of the sixth embodiment.

Referring to FIGS. 18 and 19, the restricting portion 251 is comprised of the aforementioned recess with the inner surface 51a and partial concave grooves 2511 that are each further deeply dented in the inner surface 51a of the bottom toward the fluid chamber relative to the inner surface 51a of the bottom. The partial concave grooves 2511 are configured to radially expand from the center portion of the inner surface 51a of the bottom. The partial concave grooves 2511 extend to reach the inner peripheral wall of the restricting portion 251.

The restricting portion 251 of the eighth embodiment is comprised of the inner surface 51a of the bottom that the first end 53a of the intervening member 53 faces, and the partial concave grooves 2511 partially dented relative to the inner surface 51a of the bottom so as to be far away from the intervening member 53. This configuration of the fluid machine 1 of the eighth embodiment enables oil that seeps from, for example, the intervening member 53, which may contain worn powder, to be stored in each partial concave groove 2511. This prevents one or more slide members, such as the intervening member 53, the orbiting scroll member 20, or the other components, from becoming an abnormal wearing state. In particular, the partial concave grooves 2511 are located from the center of the bottom surface 51a of the restricting portion 251 to a portion adjacent to the inner peripheral wall thereof, thus improving the recovery performance of the fluid machine 1 for abnormal materials located within a wider region of the bottom surface 51a of the restricting portion 251.

### Ninth Embodiment

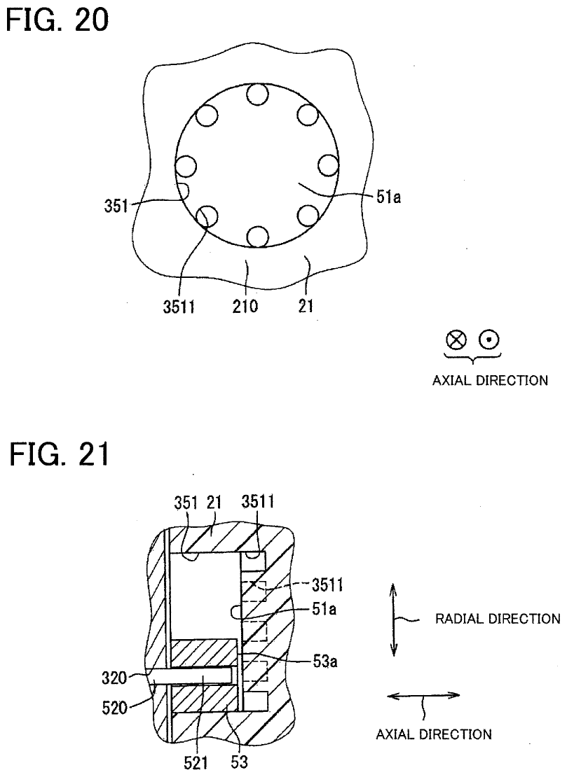

The following describes the ninth embodiment with reference to FIGS. 20 and 21. The ninth embodiment is configured such that the configuration of each restricting portion 351 of the ninth embodiment is modified as compared to that of the sixth embodiment. The following therefore describes only the modified portion of the ninth embodiment, because the remaining portion of the ninth embodiment is substantially identical to the corresponding portion of the sixth embodiment.

Referring to FIGS. 20 and 21, the restricting portion 351 is comprised of the aforementioned recess with the inner surface 51a that the first end 53a of the intervening member 53 faces, and partial concave grooves 3511 that are each further deeply dented in the inner surface 51a of the bottom toward the fluid chamber relative to the inner surface 51a of the bottom. The partial concave grooves 3511 are each shaped as a cylindrical recess, and are arranged along the inner peripheral edge of the inner surface 51a of the bottom at given intervals, preferably at regular intervals.

The restricting portion 351 of the ninth embodiment is comprised of the inner surface 51a of the bottom that the first end 53a of the intervening member 53 faces, and the partial concave grooves 3511 partially dented relative to the inner surface 51a of the bottom so as to be far away from the intervening member 53. This configuration of the fluid machine 1 of the ninth embodiment enables oil that seeps from, for example, the intervening member 53, which may contain worn powder, to be stored in each partial concave groove 3511. This prevents one or more slide members, such as the intervening member 53, the orbiting scroll member 20, or the other components, from becoming an abnormal wearing state. The partial concave grooves 3511 improve the amount of recovery of oil and/or foreign materials around the inner peripheral wall of the restricting portion 351, thus improving the recovery performance of the fluid machine 1 for abnormal materials that move toward the inner peripheral wall of the restricting portion 351 by centrifugal force.

### Tenth Embodiment

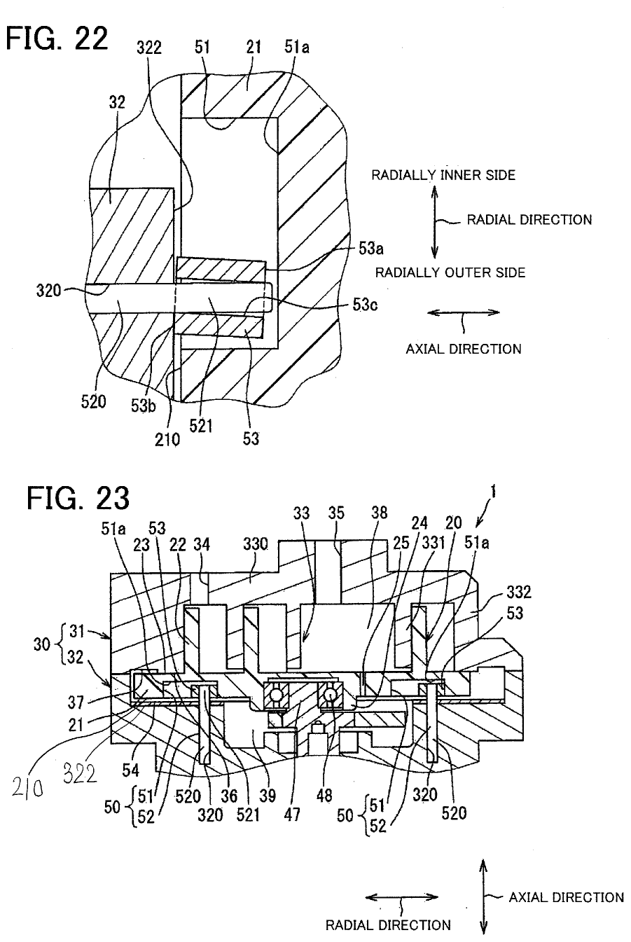

The following describes the tenth embodiment with reference to FIG. 22. The tenth embodiment is configured such that the first end 53a of each intervening member 53 and the inner surface 51a of the corresponding restricting portion 51 have a specific positional relationship. The following therefore describes only the specific positional relationship of the tenth embodiment, because the remaining parts of the tenth embodiment are substantially identical to those of the sixth embodiment.

Referring to FIG. 22, the projection 52 has an outer diameter dimension that is smaller than an inner diameter dimension of the intervening member 53. That is, the intervening member 53 is loosely fitted around the slide portion 521 with a clearance formed therearound.

As illustrated in FIG. 22, if the intervening member 53 is maximally inclined toward the projection 52, a part of the inner peripheral wall of the intervening member 53 abuts on the outer peripheral surface of the slide portion 521. While the part of the inner peripheral wall of the intervening member 53 is in contact with the outer peripheral surface of the slide portion 521, the first side of the second housing 32 (see reference numeral 322), the intervening member 53, and the bottom surface 51a of the restricting portion 51 have a predetermined positional relationship arranged to prevent (i) the first end 53a of the intervening member 53 from being in contact with the bottom surface 51a and (ii) the second end (see reference numeral 53b) of the intervening member 53 from being in contact with the fixed member.

The restricting portion 51 of the tenth embodiment has the bottom surface 51a that the first end 53a of the intervening member 53 faces. The bottom surface 51a and the fixed member are arranged to prevent, even if the intervening member 53 being loosely fitted around the projection 52 has a posture that is maximally inclined toward the projection 52, the intervening member 53 from being in contact with both the bottom surface 51a and the fixed member.

The above fluid machine 1 having the configuration that the inner diameter dimension of the intervening member 53 is designed to be larger than the outer diameter dimension of the slide portion 521 achieves the following effect. Specifically, even if the intervening member 53 is inclined greatly toward the projection 52, the above configuration prevents each of the first and second ends 53a and 53b of the intervening member 53 from sliding while being in contact with the corresponding one of the bottom surface 51a and the fixed member. This therefore inhibits abnormal wearing and/or agglutination of the intervening member 53, the fixed member, and/or the bottom surface 51a.

### Eleventh Embodiment

The following describes the eleventh embodiment with reference to FIG. 23. The eleventh embodiment is configured such that each intervening member has a displacement restricting structure, which is different from the configuration of the sixth embodiment. The following therefore describes only the different portion of the configuration of the eleventh embodiment, because the remaining portion of the eleventh embodiment is substantially identical to the corresponding portion of the sixth embodiment.

Referring to FIG. 23, a platy member 54 is provided between the second end 53b of the intervening member 53 in its axial direction and the fixed member. The platy member 54 is arranged between the second side of the base 21 (see reference numeral 210) and the second side 322 of the second housing 32 to face both the second side 210 and the first side 322. The platy member 54 is designed as a single member arranged to face all the intervening members 53 included in the fluid machine 1.

The platy member 54 serves as the displacement restricting structure that prevents the intervening members 53 from axially displacing to be left out from the restricting portion 51. For example, the platy member 54 is made of a metal material, and also serves as a platy member for reducing the wearing of the intervening member 53 and/or the fixed member.

The projection 52 of the eleventh embodiment is comprised of the fixture base 520 and the slide portion 521. The fixture base 520 at the first end of the projection 52 is fixed to the fixed member, and the slide portion 521 at the second end of the projection 52 is movable while being restricted, via the intervening member 53, by the inner peripheral wall of the restricting portion 51.

Additionally, the fluid machine 1 includes the platy member 54 disposed between the second end 53b of each intervening member 53 in its axial direction and the fixed member.

This configuration enables the platy member 54 to prevent each intervening member 53 from being in contact with the fixed member, making it possible to reduce the wearing of each of the intervening members 53 and the fixed member.

### Twelfth Embodiment

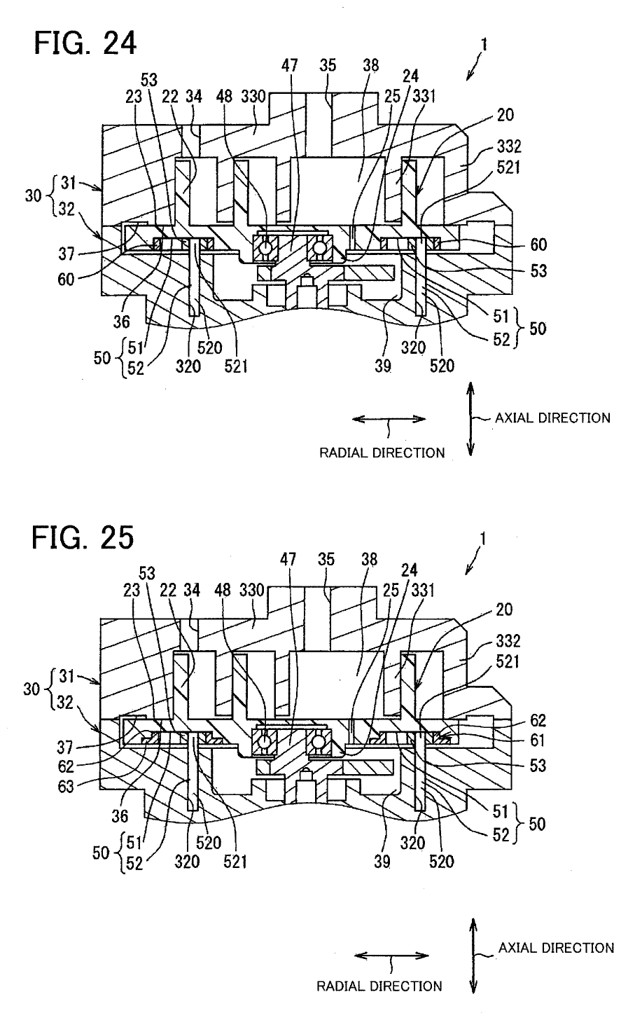

The following describes the twelfth embodiment with reference to FIG. 24. The twelfth embodiment is specially configured such that sleeve members 60 are provided; each of the sleeve members 60 restricts orbiting of the corresponding one of the intervening members 53. The above specific configuration of the twelfth embodiment is only different from the configuration of the sixth embodiment. The following therefore describes only the specific configuration of the twelfth embodiment, because the remaining configuration of the twelfth embodiment is substantially identical to the corresponding configuration of the sixth embodiment.

Referring to FIG. 24, the sleeve member 60 having a tubular shape is filled in the recess of the restricting portion 51 of each rotation prevention mechanism 50. The sleeve member 60 can be fixed to the recess or be movable in the recess. The slide portion 521 and the intervening member 53 are configured to orbit, with orbiting of the orbiting scroll member 20, inside the sleeve member 60 while being restricted by the inner peripheral wall of the sleeve member 60. The sleeve member 60 is preferably made of a fiber-reinforced resin material or a metal material.

For example, the sleeve member 60 is made of a metal material.

This configuration results in the orbiting scroll member 20 being not in slidable contact with the outer peripheral wall of the intervening member 53. This makes it possible to select a material for the orbiting scroll member 20 without consideration of required anti-wear property and required surface hardness for the slide portions.

As described above, the fluid machine 1 according to the twelfth embodiment includes the sleeve members 60, each of which is disposed between the inner peripheral wall of the restricting portion 51 and the intervening member 53 of each rotation prevention mechanism 50. Each sleeve member 60 is made of a fiber-reinforced resin material or a metal material. This configuration makes it possible to form the inner peripheral wall of the restricting portion 51 using any material with high molding accuracy, which is not limited to a fiber-reinforced resin material.

### Thirteenth Embodiment

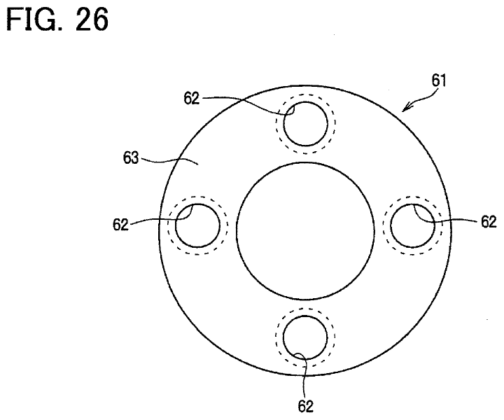

The following describes the thirteenth embodiment with reference to FIGS. 25 and 26. The thirteenth embodiment is specially configured such that a sleeve member 61 is provided; the configuration of the sleeve member 61 is different from that of each sleeve member 60 according to the twelfth embodiment. The following therefore describes only the configuration of the sleeve member 61 of the thirteenth embodiment, because the remaining configuration of the thirteenth embodiment is substantially identical to the corresponding configuration of the twelfth embodiment.

Referring to FIGS. 25 and 26, the sleeve member 61 is comprised of a plurality of tubular members 62 and a joint member 63 joins the tubular members 62 to each other, so that the sleeve member 61 serves as the assembly of the circumferentially joined tubular members 62.

The tubular members 62 are filled in the recesses of the respective restricting portions 51. That is, the number of the tubular members 62 is identical to the number of the restricting portions 51. FIG. 26 illustrates four restricting portions 51 and four tubular members 62 as an example, but the number of the restricting portions 51 and that of the tubular members 62 can be set to three or five or more.

The joint member 63 can be embedded in the orbiting scroll member 20 as illustrated in FIG. 25, or can be mounted to project from the orbiting scroll member 20.

The sleeve member 61 is configured as an assembly of the tubular members 62 and joint member 63, making it possible to easily mount the assembled sleeve member 61 to the orbiting scroll member 20 and reduce the number of components of the fluid machine 1 of the thirteenth embodiment.

### Modifications

The present disclosure is not limited to the above embodiments, and can be appropriately modified.

The above embodiments, which are relative to each other, can be appropriately combined with each other except that obviously impossible combinations. One or more components in each embodiment are not necessarily essential components except that (i) one or more components that are described as one or more essential components or (ii) one or more components that are principally essential.

Specific values disclosed in each embodiment, each of which represents the number of components, a physical quantity, and/or a range of a physical parameter, are not limited thereto except that (i) the specific values are obviously essential or (ii) the specific values are essential in principle.

The specific shape of each component described in each embodiment is not limited thereto except that (1) the specific shape is described to be essential or (2) the specific shape is required in principle. Similarly, the specific positional relationship between components described in each embodiment is not limited thereto except that (1) the specific positional relationship is described to be essential or (2) the specific positional relationship is required in principle.

While the illustrative embodiments of the present disclosure have been described herein, the present disclosure is not limited to the embodiments and their modifications described herein, but includes any and all embodiments having modifications, omissions, combinations (e.g., of aspects across various embodiments), adaptations and/or alterations as would be appreciated by those in the art based on the present disclosure within the scope of the present disclosure.

The present disclosure includes replacement of one or more elements included in one of the embodiments with one or more elements included in another of the embodiments. The present disclosure also includes combination of one or more elements included in one of the embodiments with one or more elements included in another of the embodiments.

The technical scope disclosed in the present disclosure is represented by the descriptions of claims, and various modifications of the descriptions of the claims, which is within the technical scope of the claims, can be included in the present disclosure.

In each embodiment, the orbiting slide surface 230 is formed on the first side of the orbiting base 260 of the orbiting scroll member 200, which is closer to the fixed scroll member 100 than the second side is. In addition, the housing slide surface 360 is formed on a portion of the first housing 301, which faces the orbiting slide surface 230. The present disclosure is however not limited to the configuration.

Specifically, the orbiting slide surface 230 can be formed on the second side of the orbiting base 260, which is farther from the fixed scroll member 100 than the first side is, and the housing slide surface 360 can be formed on a portion of the second housing 302, which faces the orbiting slide surface 230.

In each embodiment, the motor unit 400 is used as a drive source of the orbiting scroll member 200, but another drive source, such as an engine, can be used. The fluid machine according to each embodiment can be configured such that torque generated from a drive source separately arranged from a compression mechanism for compressing fluid of the fluid machine is supplied to the compression mechanism via a pulley and/or a belt.

In each embodiment, the coating member 3610 or 5310 is applied to at least one of the housing slide surface 360 and the metallic spacer 530, but the present disclosure is not limited thereto. Specifically, no coating is applied to at least one of the housing slide surface 360 and the metallic spacer 530. In this modification, it is possible to suppress an increase in temperature of the orbiting scroll member 200 to thereby prevent melt-adhesion between the slide surfaces as long as load applied to the scroll members 100 and 200 is smaller than or equal to an allowable upper limit.

In each embodiment, the fixed scroll member 100 is made of a resin material, but can be made of, for example, a metal material.

In each of the corresponding embodiments, the projection is designed to have a bar shape, such as a pin shape, but can be designed to have a hollow bar shape or a tubular shape as long as the modified projection is capable of accomplishing the above one or more objects.

In each of the corresponding embodiments, the fixed scroll member 33 constitute the first housing 31, but can be independently constructed as a separate member from the first housing 31. The separated fixed scroll member 33 is fixedly mounted to the first housing 31 so as to be integrated with the first housing 31. The fixed scroll member 33 is made of a metal material, such as aluminum, but can be made of a rein material. The fixed scroll member 33 made of a rein material can constitute the first housing 31 or can be constructed as individual member fixedly mounted to the first housing 31.

The fixed wrap member and the orbiting wrap member in each of the corresponding embodiments have an asymmetric spiral configuration with their wrap angle ranges being different from each other, but can have a symmetrical spiral configuration with their wrap angle ranges being substantially identical to each other.

According to a first aspect shown in a part of all of the above embodiments, a scroll-type fluid machine for discharging sucked fluid includes a fixed scroll member, an orbiting scroll member, a housing, an orbiting slide surface, and a housing slide surface.

The fixed scroll member includes a fixed base and a fixed tooth member mounted to the fixed base to have a spiral shape.

The orbiting scroll member is made of a resin material and includes (i) an orbiting base arranged to face the fixed base, and (ii) an orbiting tooth member mounted to the orbiting base to have a spiral shape. The fixed tooth member and the orbiting scroll member are fitted to each other. The orbiting scroll member is configured to orbit around a predetermined center axis.

The housing has an outer wall exposed to atmospheric air and is configured to house the fixed scroll member and the orbiting scroll member with the fixed scroll member being fixed thereto.

The orbiting slide surface is located to be radially outside of the orbiting base of the orbiting scroll member.

The housing slide surface is formed on a portion of the housing; the portion is made of a metal material and being arranged to face the orbiting slide surface. The orbiting slide surface is in slidable contact with the housing slide surface.

According to a second aspect, the housing slide surface has a coating formed thereon. The coating is composed of fluorine or molybdenum disulfide that has a self-lubricating characteristic.

The coating coated on the housing slide surface enables the frictional coefficient of the housing slide surface to be lower.

The coating coated on the housing slide surface is designed as a thin film, making it possible to maintain heat transfer from the orbiting scroll member to the housing.

An experiment shows that using the coating makes it possible to suppress an increase in temperature of the orbiting slide surface and the housing slide surface, even if the orbiting slide surface is slidably contacted with the housing slide surface under high load to the housing slide surface.

Accordingly, the fluid machine is configured to have a higher wear resistance and prevent melt-adhesion between the slide surfaces even if the fluid machine discharges high-pressure air, making it possible for the fluid machine to have a higher reliability.

According to a third aspect, the fixed scroll member is made of a resin material.

This enables a value of the thermal expansion rate of the fixed scroll member to be substantially equal to a value of the thermal expansion rate of the orbiting scroll member. The scroll members have a stable function of compressing air independently of their temperature changes. Using the scroll members each made of a resin material enables the manufacturing cost of the fluid machine to be further reduced.

According to a fourth aspect, the fixed scroll member and the orbiting scroll member are arranged to define a predetermined clearance between a part of a side surface of the fixed tooth member and a corresponding part of an opposite side surface of the orbiting tooth member while the orbiting scroll member is orbiting. The part of the side surface of the fixed tooth member and the corresponding part of the side surface of the orbiting tooth member are closest to each other while the orbiting wall member is orbiting.

This configuration prevents the orbiting tooth member from sliding on the fixed tooth member even if each of the scroll members is made of a resin material, thus preventing a temperature increase in each of the respective tooth members, and preventing melt-adhesion between the tooth members. This therefore improves the reliability of the fluid machine.

According to a fifth aspect, the fixed tooth member has a tip end located to be closer to the fixed base than the orbiting slide surface and the housing slide surface are.

This arrangement prevents the tip end of the fixed tooth member from being in contact with the orbiting base, thus enabling the orbiting slide surface to slide on the housing slide surface while being reliably in contact with the housing slide surface. This reliable contact between the slide surfaces prevents high-pressure air in a space, such as a back-pressure chamber, located outside the fixed scroll member and orbiting scroll member, from leaking into a low-pressure space located inside of the fixed scroll member. The fluid machine accordingly prevents reduction in the compression efficiency of air.

According to a sixth aspect, the fixed base has opposing first and second surfaces, the first surface being closer to the orbiting base than the second surface is; and a fixed portion of the housing to which the fixed scroll member is fixed is located to be closer to the orbiting base than a middle portion that is defines as a middle portion between the housing side surface and the first side surface of the fixed base.

This arrangement enables, even if the fixed scroll member thermally expands due to its temperature change, the fixed scroll member to move so that the fixed base is away from the housing slide surface. This prevents the tip end of the fixed tooth member from being in contact with the orbiting base, thus enabling the orbiting slide surface to slide on the housing slide surface while being reliably in contact with the housing slide surface. This reliable contact between the slide surfaces prevents high-pressure air in a space, such as a back-pressure chamber, located outside the fixed scroll member and orbiting scroll member, from leaking into a low-pressure space located inside of the fixed scroll member. The fluid machine accordingly prevents reduction in the compression efficiency of air.

According to a seventh aspect, the fixed tooth member of the fixed scroll member has a notched groove formed in a radially outer portion thereof. The radially outer portion of the fixed tooth member is located to be adjacent to the orbiting base. The housing has an overhang portion formed to be fitted in the notched groove. The overhang portion has a surface that faces the orbiting slide surface, the surface of the overhang portion constituting the housing slide surface.

This results in the inner diameter of the housing slide surface being smaller, so that the outer diameter of the orbiting slide surface, which slides on the housing slide surface, being smaller, thus making smaller the outer diameter of the orbiting base. This therefore makes smaller the size of the fluid machine in its radial direction.

The fluid machine according to an eighth aspect includes a biasing member disposed between the fixed base and the housing. The biasing member is configured to bias the fixed base toward the orbiting scroll member to accordingly cause the overhang portion to be in contact with the notched groove of the fixed scroll member.

This enables the posture of the fixed scroll member to be stable even if the fluid machine is deactivated.

According to a ninth aspect, the orbiting base has opposing first and second sides, the first side being closer to the fixed scroll member than the second side is. The orbiting slide surface is formed on the first side of the orbiting base. The housing has an inner wall. The fluid machine further includes a back-pressure chamber provided between the second side of the orbiting base and the inner wall of the housing, and configured such that fluid compressed by the fixed scroll member and the orbiting scroll member is supplied into the back-pressure chamber. A pressure of the fluid in the back-pressure chamber causes the orbiting scroll member to be biased toward the fixed scroll member, resulting in the orbiting slide surface formed on the first side of the orbiting base being in slidable contact with the housing slide surface.

Let us assume that a comparative fluid machine includes the orbiting base with the orbiting side surface formed on a second side of the orbiting base, which is opposite to the first side of the orbiting base and located farther from the fixed scroll member; coating is formed on the housing side surface with which the orbiting side surface is in slidable contact. In this comparative fluid machine, if coating is required for the unillustrated rotation prevention mechanism for preventing rotation of the orbiting scroll member, the manufacturing cost of the comparative fluid machine may be increased.

In contrast, the orbiting scroll member of the ninth aspect is configured such that the orbiting slide surface is formed on the first side of the orbiting base located to be closer to the fixed scroll member. If the coating member is applied to the housing slide surface with which the orbiting slide surface is in slidable contact, this configuration in which the orbiting slide surface is located to be closer to the fixed scroll member enables the configuration of the fluid machine to be simpler, resulting in the manufacturing cost of the fluid machine being lower.

According to a tenth aspect, the housing has a concave recess formed in a radially outer portion of the housing side surface. The concave recess is dented inwardly in the radially outer portion of the housing side surface to be away from the orbiting slide surface. The concave recess is in a non-contact with the orbiting slidable contact surface. The housing slide surface has a radial width, and the orbiting scroll member is eccentrically arranged from the center axis of an orbiting of the orbiting scroll member by a predetermined eccentric distance. The radial width is set to be smaller than or equal to double the eccentric distance.

This setting of the radial width of the housing slide surface enables the orbiting slide surface to intermittently slide on the housing slide surface 360. In other words, this setting enables the slide ratio of the orbiting slide surface to the housing slide surface to be lower than 100%; the slide ratio represents a ratio of a time for which a predetermined slidable point on the orbiting slide surface slides on the housing slide surface to a total working time of the fluid machine. This therefore reduces the amount of heat generated due to the sliding of the orbiting slide surface on the housing slide surface, thus suppressing temperature increase in the slide surfaces.

According an eleventh aspect, a scroll-type fluid machine for discharging sucked fluid, the scroll-type fluid machine includes a fixed scroll member, an orbiting scroll member, a first housing, a second housing, an orbiting slide surface, and a spacer.

The fixed scroll member includes a fixed base and a fixed tooth member mounted to the fixed base to have a spiral shape. The orbiting scroll member is made of a resin material and includes an orbiting base arranged to face the fixed base, and an orbiting tooth member mounted to the orbiting base to have a spiral shape. The fixed tooth member and the orbiting scroll member are fitted to each other. The orbiting scroll member is configured to orbit around a predetermined center axis.

At least one of the first and second housings is made of a metal material and has an outer wall exposed to atmospheric air. An assembly of the first and second housing is configured to house the fixed scroll member and the orbiting scroll member with the fixed scroll member being fixed to the assembly of the first and second housings.

The orbiting slide surface is located to be radially outside of the orbiting base of the orbiting scroll member. The metallic spacer is mounted to a portion of the first housing or the second housing; the portion is arranged to face the orbiting slide surface. The metallic spacer has a surface with which the orbiting slide surface being in slidable contact. The surface of the metallic spacer with which the orbiting slide surface being in slidable contact has a coating formed thereon. The coating has a self-lubricating characteristic.

Applying the coating to the metallic spacer without applying coating to the first housing or the second housing, which has larger in size than the metallic spacer enables the load required to perform the coating-member applying process to be smaller. This therefore enables the manufacturing cost of the fluid machine to be lower.

In addition, it is possible to dissipate heat from one surface of the metallic spacer into atmospheric air. The fluid machine of the eleventh aspect can achieve beneficial effects that are substantially identical to the beneficial effects achieved by the first aspect.

It is possible to freely combine the configuration described in the eleventh aspect to the configuration descried in one of the third to tenth aspects as described below.

Specifically, the fixed scroll member can be made of a resin material in addition to the configuration of the eleventh aspect.

In addition to the eleventh aspect, the fixed scroll member and the orbiting scroll member can be arranged to define a predetermined clearance between a part of a side surface of the fixed tooth member and a corresponding part of an opposite side surface of the orbiting tooth member while the orbiting scroll member is orbiting. The part of the side surface of the fixed tooth member and the corresponding part of the side surface of the orbiting tooth member are closest to each other while the orbiting wall member is orbiting.

In addition to the eleventh aspect, the fixed tooth member can have a tip end located to be closer to the fixed base than the orbiting slide surface and the housing slide surface are.

In addition to the eleventh aspect, a fixed portion of the housing to which the fixed scroll member is fixed can be located to be closer to the orbiting base than a middle portion that is defines as a middle portion between the housing side surface and the first side surface of the fixed base.

In addition to the eleventh aspect, the housing can have an overhang portion formed to be fitted in the notched groove. The overhang portion can have a surface that faces the orbiting slide surface, the surface of the overhang portion constituting the housing slide surface.

In addition to the eleventh aspect, the fluid machine can include a biasing member disposed between the fixed base and the housing, and configured to bias the fixed base toward the orbiting scroll member to accordingly cause the overhang portion to be in contact with the notched groove of the fixed scroll member.

In addition to the eleventh aspect, a pressure of the fluid in the back-pressure chamber can cause the orbiting scroll member to be biased toward the fixed scroll member, resulting in the orbiting slide surface formed on the first side of the orbiting base being in slidable contact with the housing slide surface.

In addition to the eleventh aspect, the radial width of the housing slide surface can be set to be smaller than or equal to double the eccentric distance by which the orbiting scroll member is eccentrically arranged from the center axis of the orbiting of the orbiting scroll member.

According to a twelfth aspect, a scroll-type fluid machine for discharging sucked fluid includes a fixed scroll member, an orbiting scroll member, and a plurality of rotation prevention mechanisms.

The fixed scroll member includes a fixed warp member having a spiral shape.

The orbiting scroll member includes an orbiting wrap member arranged to define a compression chamber between the fixed scroll member and the orbiting scroll member.

Each of the rotation prevention mechanisms includes a hollow restricting portion having a circular inner peripheral wall, and a projection having predetermined first surface hardness and first predetermined surface roughness. The projection is configured to orbit inside the restricting portion while being restricted by the inner peripheral wall of the restricting portion. Each of the rotation prevention mechanism includes a ring-shaped intervening member made of a material having predetermined second surface hardness. The intervening member has an inner peripheral portion that has predetermined second surface roughness. The intervening member is located to intervene between the projection and the inner peripheral wall of the restricting portion. The intervening member is configured to slide on both the projection and the inner peripheral wall of the restricting portion. The second surface hardness of the intervening member is set to be lower than the first surface hardness of the projection, and the first surface roughness of the projection is set to be smaller than the second surface roughness of the inner peripheral portion of the intervening member.

It is also possible to freely combine the configuration described in the twelfth aspect to the configuration descried in one of the first to twelfth aspects.

What is claimed is:

1. A scroll-type fluid machine for discharging sucked fluid, the scroll-type fluid machine comprising:
a fixed scroll member including a fixed base and a fixed tooth member mounted to the fixed base to have a spiral shape;
an orbiting scroll member made of a resin material and including:
an orbiting base arranged to face the fixed base; and
an orbiting tooth member mounted to the orbiting base to have a spiral shape, the fixed tooth member and the orbiting scroll member being fitted to each other, the orbiting scroll member being configured to orbit around a predetermined center axis;
a housing configured to house the fixed scroll member and the orbiting scroll member with the fixed scroll member being fixed thereto;
an orbiting slide surface located to be radially outside of the orbiting base of the orbiting scroll member; and
a housing slide surface formed on a portion of the housing, the portion being made of a metal material and being arranged to face the orbiting slide surface, the orbiting slide surface being in slidable contact with the housing slide surface, the portion of the housing having an outer wall exposed to atmospheric air.

2. The fluid machine according to claim 1, wherein:
the housing slide surface has a coating formed thereon, the coating being composed of fluorine or molybdenum disulfide that has a self-lubricating characteristic.

3. The fluid machine according to claim 1, wherein:
the fixed scroll member is made of a resin material.

4. The fluid machine according to claim 1, wherein:
the fixed scroll member and the orbiting scroll member are arranged to define a predetermined clearance between a part of a side surface of the fixed tooth member and a corresponding part of an opposite side surface of the orbiting tooth member while the orbiting scroll member is orbiting, the part of the side surface of the fixed tooth member and the corresponding part of the side surface of the orbiting tooth member being closest to each other while the orbiting wall member is orbiting.

5. The fluid machine according to claim 1, wherein:
the fixed tooth member has a tip end located to be closer to the fixed base than the orbiting slide surface and the housing slide surface are.

6. The fluid machine according to claim 1, wherein:
the fixed base has opposing first and second surfaces, the first surface being closer to the orbiting base than the second surface is; and
a fixed portion of the housing to which the fixed scroll member is fixed is located to be closer to the orbiting base than a middle portion that is defines as a middle portion between the housing side surface and the first side surface of the fixed base.

7. The fluid machine according to claim 1, wherein:
the fixed tooth member of the fixed scroll member has a notched groove formed in a radially outer portion thereof; the radially outer portion of the fixed tooth member being located to be adjacent to the orbiting base; and
the housing has an overhang portion formed to be fitted in the notched groove; and
the overhang portion has a surface that faces the orbiting slide surface, the surface of the overhang portion constituting the housing slide surface.

8. The fluid machine according to claim 7, further comprising:
a biasing member disposed between the fixed base and the housing, and configured to bias the fixed base toward the orbiting scroll member to accordingly cause the overhang portion to be in contact with the notched groove of the fixed scroll member.

9. The fluid machine according to claim 1, wherein:
the orbiting base has opposing first and second sides, the first side being closer to the fixed scroll member than the second side is, the orbiting slide surface being formed on the first side of the orbiting base; and
the housing has an inner wall,
the fluid machine further comprising:
a back-pressure chamber provided between the second side of the orbiting base and the inner wall of the housing, and configured such that fluid compressed by the fixed scroll member and the orbiting scroll member is supplied into the back-pressure chamber,
a pressure of the fluid in the back-pressure chamber causing the orbiting scroll member to be biased toward the fixed scroll member, resulting in the orbiting slide surface formed on the first side of the orbiting base being in slidable contact with the housing slide surface.

10. The fluid machine according to claim 1, wherein:
the housing has a concave recess formed in a radially outer portion of the housing side surface, the concave recess being dented inwardly in the radially outer portion of the housing side surface to be away from the orbiting slide surface, the concave recess being in a non-contact with the orbiting slidable contact surface;
the housing slide surface has a radial width; and
the orbiting scroll member is eccentrically arranged from the center axis of an orbiting of the orbiting scroll member by a predetermined eccentric distance,
the radial width being set to be smaller than or equal to double the eccentric distance.

11. A scroll-type fluid machine for discharging sucked fluid, the scroll-type fluid machine comprising:
a fixed scroll member including a fixed base and a fixed tooth member mounted to the fixed base to have a spiral shape;
an orbiting scroll member made of a resin material and including:
an orbiting base arranged to face the fixed base; and
an orbiting tooth member mounted to the orbiting base to have a spiral shape, the fixed tooth member and the orbiting scroll member being fitted to each other, the orbiting scroll member being configured to orbit around a predetermined center axis;
a first housing;
a second housing, at least one of the first and second housings being made of a metal material and having an outer wall exposed to atmospheric air, an assembly of the first and second housing being configured to house the fixed scroll member and the orbiting scroll member with the fixed scroll member being fixed to the assembly of the first and second housings;
an orbiting slide surface located to be radially outside of the orbiting base of the orbiting scroll member; and
a metallic spacer mounted to a portion of the first housing or the second housing, the portion being arranged to face the orbiting slide surface, the metallic spacer having a surface with which the orbiting slide surface being in slidable contact,
the surface of the metallic spacer with which the orbiting slide surface being in slidable contact having a coating formed thereon, the coating having a self-lubricating characteristic.

12. A scroll-type fluid machine for discharging sucked fluid, the scroll-type fluid machine comprising:
a fixed scroll member including a fixed warp member having a spiral shape;
an orbiting scroll member including an orbiting wrap member arranged to define a compression chamber between the fixed scroll member and the orbiting scroll member, the compression chamber being configured to compress fluid sucked thereinto and discharge the compressed fluid; and
a plurality of rotation prevention mechanisms for preventing rotation of the orbiting scroll member, each of the rotation prevention mechanisms comprising:
a hollow restricting portion having a circular inner peripheral wall;
a projection having predetermined first surface hardness and first predetermined surface roughness, and configured to orbit inside the restricting portion while being restricted by the inner peripheral wall of the restricting portion; and
a ring-shaped intervening member made of a material having predetermined second surface hardness, the intervening member having an inner peripheral portion that has predetermined second surface roughness, the intervening member being located to intervene between the projection and the inner peripheral wall of the restricting portion, the intervening member being configured to slide on both the projection and the inner peripheral wall of the restricting portion,
the second surface hardness of the intervening member being set to be lower than the first surface hardness of the projection,
the first surface roughness of the projection being set to be smaller than the second surface roughness of the inner peripheral portion of the intervening member.

13. The scroll-type fluid machine according to claim 12, wherein:
the intervening member is made of a metal material as the material, the metal material containing at least one of copper and tin.

14. The scroll-type fluid machine claim 12, wherein:
the intervening member is comprised of an oil-bearing porous body.

15. The scroll-type fluid machine according to claim 14, wherein:
the intervening member has a first end and a second end opposite to the first end in an axial direction thereof; and
the restricting portion has:
a bottom surface arranged to face the first end of the intervening member; and
a partial concave portion that is partially dented relative to the bottom surface to be away from the intervening member.

16. The scroll-type fluid machine according to claim 12, wherein the intervening member contains solid lubricant agent.

17. The scroll-type fluid machine according to claim 12, wherein:
the intervening member has a first end and a second end opposite to the first end in an axial direction thereof;
the projection has opposing first and second ends and comprises:
a slide portion located at the first end and restricted by the inner peripheral wall of the restricting portion via the intervening member; and
a fixture base located at the second end and fixed to a fixed member;
the restricting portion has a bottom surface that the first end of the intervening member; and
the bottom surface and the fixed member are arranged to prevent, if the intervening member fitted around the projection has a posture that is maximally inclined toward the projection, the intervening member from being in contact with both the bottom surface and the fixed member.

18. The scroll-type fluid machine according to claim 12, wherein:
the intervening member has an inner diameter dimension and an outer diameter dimension, and a ratio of the outer diameter dimension to the inner diameter dimension is set to more than or equal to 2.

19. The scroll-type fluid machine claim 12, wherein:
the intervening member has a first end and a second end opposite to the first end in an axial direction thereof;
the projection has opposing first and second ends and comprises:
a slide portion located at the first end and restricted by the inner peripheral wall of the restricting portion via the intervening member; and
a fixture base located at the second end and fixed to a fixed member,
the scroll type fluid machine further comprising:
a platy member disposed between the second end of the intervening member and the fixed member.

20. The scroll-type fluid machine according to claim 12, wherein:
the inner peripheral wall of the restricting portion constitutes the orbiting scroll member; and
the orbiting scroll member is made of a fiber-reinforced resin material.

21. The scroll-type fluid machine according to claim 12, further comprising:
a sleeve member disposed between the inner peripheral wall of the restricting portion and the intervening member,
wherein the sleeve member is made of a fiber-reinforced resin material or a metal material.

22. The scroll-type fluid machine according to claim 12, wherein:
the orbiting scroll member comprises a base to which the orbiting wrap member is mounted,
the scroll-type fluid machine further comprising:
a housing provided to be integral with or individually separated from the fixed scroll member, the housing being configured to house the orbiting scroll member;
an orbiting slide surface located to be radially outside of the base of the orbiting scroll member; and
a housing slide surface formed on a portion of the housing, the portion being made of a metal material and being arranged to face the orbiting slide surface, the orbiting slide surface being in slidable contact with the housing slide surface, the portion of the housing having an outer wall exposed to atmospheric air.

23. The scroll-type fluid machine according to claim 22, wherein:
the housing slide surface has a coating formed thereon, the coating being composed of fluorine or molybdenum disulfide that has a self-lubricating characteristic.

24. The scroll-type fluid machine according to claim 12, wherein:
the orbiting scroll member comprises a base to which the orbiting wrap member is mounted,
the scroll-type fluid machine further comprising:
a first housing;
a second housing, at least one of the first and second housings being made of a metal material and having an outer wall exposed to atmospheric air, the first and second housing being provided to be integral with or individually separated from the fixed scroll member, an assembly of the first and second housing being configured to house the fixed scroll member and the orbiting scroll member;
an orbiting slide surface located to be radially outside of the base of the orbiting scroll member; and
a metallic spacer mounted to a portion of the first housing or the second housing, the portion being arranged to face the orbiting slide surface, the metallic spacer having a surface with which the orbiting slide surface being in slidable contact,
the surface of the metallic spacer with which the orbiting slide surface being in slidable contact having a coating formed thereon, the coating having a self-lubricating characteristic.
